(19) United States
(12) Patent Application Publication
(10) Pub. No.: US 2026/0331757 A1
(43) Pub. Date: Oct. 22, 2026

(54) VEHICULAR ANTENNA DEVICE

(71) Applicant: YOKOWO CO., LTD., Tokyo (JP)

(72) Inventors: Takashi NOZAKI, Tomioka-shi, Gunma (JP); Noritaka TERASHITA, Tomioka-shi, Gunma (JP)

(73) Assignee: YOKOWO CO., LTD., Tokyo (JP)

(21) Appl. No.: 19/115,571

(22) PCT Filed: Sep. 28, 2023
(86) PCT No.: PCT/JP2023/035450

§ 371 Date: Mar. 26, 2025

(30) Foreign Application Priority Data
Sep. 28, 2022 (JP) 2022-154708

(51) Int. Cl. H01Q 1/32

(52) U.S. Cl. CPC H01Q 1/3275

(57) ABSTRACT

A vehicular antenna device includes a ground plate and an antenna element disposed on an upper surface side of the ground plate. The antenna element includes a conductor plate facing the ground plate, a feeding conductor extending toward the ground plate from one side portion of the conductor plate, a ground conductor extending toward the ground plate from an opposing portion of the conductor plate opposite the one side portion, and a connection conductor located between the feeding conductor and the ground conductor and electrically connected to the ground plate and the conductor plate.

### TECHNICAL FIELD

The present invention relates to a vehicular antenna device.

### BACKGROUND ART

In recent years, various antenna elements having a conductor plate facing a ground plate have been developed.

Patent Document 1 discloses an example of an antenna element. This antenna element has a rectangular table, a vertical feeding flat plate, and two posts. The vertical feeding flat plate is disposed at the center of the table. The two posts are electrically connected to the ground plate. The two posts are disposed on opposite sides of the vertical feeding flat plate.

Patent Document 2 discloses an example of an antenna element. This antenna element has a substantially quadrangular plate-shaped conductor, two feeding terminals, and two fixed legs. The two feeding terminals and the two fixed legs are provided on two sides of the plate-like conductor facing each other. One of the two feeding terminals is electrically connected to the feeding point. The other of the two feeding terminals is electrically connected to an earth surface.

### RELATED DOCUMENT

### Patent Document

Patent Document 1: Japanese Unexamined Patent Publication No. H03-253106
Patent Document 2: Japanese Unexamined Patent Publication No. H10-041736

### SUMMARY OF THE INVENTION

### Technical Problem

In the antenna element described in Patent Document 1, the two ground conductors are disposed on opposite sides of the feeding conductor. In the antenna element described in Patent Document 2, the feeding conductor and the ground conductor are provided on the same side of the conductor plate. An antenna element having a structure different from the structure of such an antenna element may need to operate in a wide frequency band.

An example of the object of the present invention is to allow a vehicular antenna device to operate in the wide frequency band. Other objects of the present invention will become apparent from the description of the present specification.

### Solution to Problem

An aspect of the present invention is
a vehicular antenna device including:
a ground plate; and
an antenna element disposed on an upper surface side of the ground plate,
in which the antenna element includes
a conductor plate facing the ground plate,
a feeding conductor extending toward the ground plate from one side portion of the conductor plate,
a ground conductor extending toward the ground plate from an opposing portion of the conductor plate opposite the one side portion, and
a connection conductor located between the feeding conductor and the ground conductor and electrically connected to the ground plate and the conductor plate.

According to the aspect described above of the present invention, the vehicular antenna device can operate in the wide frequency band.

### BRIEF DESCRIPTION OF THE DRAWINGS

FIG. 1 A perspective view of a vehicular antenna device according to Embodiment 1.

FIG. 2 A diagram showing an example of a structure of a feeding portion of an antenna element according to Embodiment 1.

FIG. 3 A diagram showing a configuration of a matching circuit of the vehicular antenna device according to Embodiment 1.

FIG. 4 A perspective view of a vehicular antenna device according to a reference embodiment.

FIG. 5 A graph showing frequency characteristics of the voltage standing wave ratio of a vehicular antenna device according to Example 1.1 and a reference example.

FIG. 6 A Smith chart of a vehicular antenna device according to Example 1.2, Example 1.3, and Example 1.4.

FIG. 7 A perspective view of a vehicular antenna device according to Embodiment 2.

FIG. 8 A perspective view of a vehicular antenna device according to a first variant of Embodiment 2.

FIG. 9 A graph showing frequency characteristics of the voltage standing wave ratio of a vehicular antenna devices according to Example 2.1, Example 2.2, Example 2.3, and Example 1.1.

FIG. 10 A graph showing frequency specification of the voltage standing wave ratio of a vehicular antenna device according to Example 2.4 and Example 2.5.

FIG. 11 A perspective view of a vehicular antenna device according to a second variant of Embodiment 2.

FIG. 12 A graph showing frequency specification of the voltage standing wave ratio of a vehicular antenna devices according to Example 2.6 and Example 2.7.

FIG. 13 A perspective view of a vehicular antenna device according to Embodiment 3.

FIG. 14 A side view of the vehicular antenna device according to Embodiment 3 as viewed from the horizontal direction perpendicular to an arrangement direction of the feeding conductor and the ground conductor.

FIG. 15 A side view of a vehicular antenna device according to a first variant of Embodiment 3 as viewed from the horizontal direction perpendicular to an arrangement direction of the feeding conductor and the ground conductor.

FIG. 16 A graph showing frequency characteristics of the voltage standing wave ratio of an antenna device according to Example 3.1 and Comparative Example.

FIGS. 17(a) and (b) are side views of the vehicular antenna device according to a second variant of Embodiment 3 as viewed from the horizontal direction perpendicular to the arrangement direction of the feeding conductor and the ground conductor.

FIG. 18 A side view of the vehicular antenna device according to a third variant of Embodiment 3 as viewed from the horizontal direction perpendicular to the arrangement direction of the feeding conductor and the ground conductor.

FIGS. 19(a), (b), and (c) are side views of the vehicular antenna device according to a fourth variant of Embodiment 3 as viewed from the horizontal direction perpendicular to the arrangement direction of the feeding conductor and the ground conductor.

FIG. 20 A side view of a vehicular antenna device according to a fifth variant of Embodiment 3 as viewed from the side where a ground conductor is located.

FIG. 21 A graph showing frequency characteristics of the voltage standing wave ratio of the antenna apparatus according to Example 3.2 and Example 3.3.

FIG. 22 A side view of a vehicular antenna device according to a sixth variant of Embodiment 3 as viewed from the side where the ground conductor is located.

FIG. 23 A graph showing frequency characteristics of the voltage standing wave ratio of the antenna apparatus according to Example 3.2 and Example 3.4.

FIGS. 24(a), (b), (c), (d), (e), and (f) are side views of the feeding conductor or the ground conductor according to a seventh variant of Embodiment 3 as viewed from the horizontal direction parallel to the arrangement direction of the feeding conductor and the ground conductor.

FIG. 25 A perspective view of a vehicular antenna device according to Embodiment 4.

FIG. 26 A diagram showing a configuration example of a matching circuit of the vehicular antenna device according to Embodiment 4.

FIG. 27 A graph showing frequency characteristics of

isolation of a vehicular antenna device according to Example 4.

FIG. 28 A perspective view of a vehicular antenna device according to Embodiment 5.

FIG. 29 A graph showing frequency characteristics of isolation of a vehicular antenna device according to Example 5.

### DESCRIPTION OF EMBODIMENTS

Hereinafter, embodiments, variants, and examples of the present invention will be described with reference to the drawings. In all the drawings, the same constitutional components are denoted by the same reference signs, and description thereof will not be repeated as appropriate.

For description of directions, an X direction, a Y direction, and a Z direction are defined. The Z direction is a direction parallel to a vertical direction. The X direction is one of horizontal directions perpendicular to the Z direction. The Y direction is one of horizontal directions perpendicular to both the Z direction and the X direction. In each of the embodiments and each of the variants, the Z direction is described as the vertical direction. In each of: the embodiments and each of the variants, the X direction is described as an arrangement direction of the feeding conductor and the ground conductor, which will be described later. In each drawing, a direction indicated by an arrow of the Z-axis is defined as an upward direction. Hereinafter, a plane perpendicular to the Z direction is referred to as an XY plane as necessary.

Hereinafter, a plane perpendicular to the X direction is referred to as a YZ plane as necessary. Hereinafter, a plane perpendicular to the Y direction is referred to as a ZX plane as necessary.

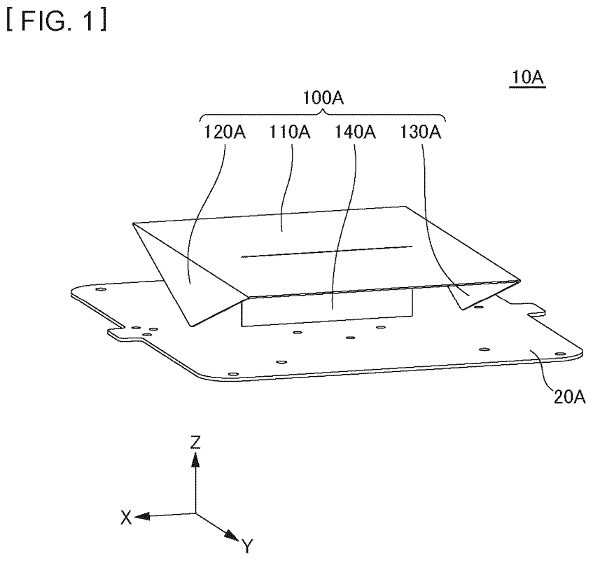

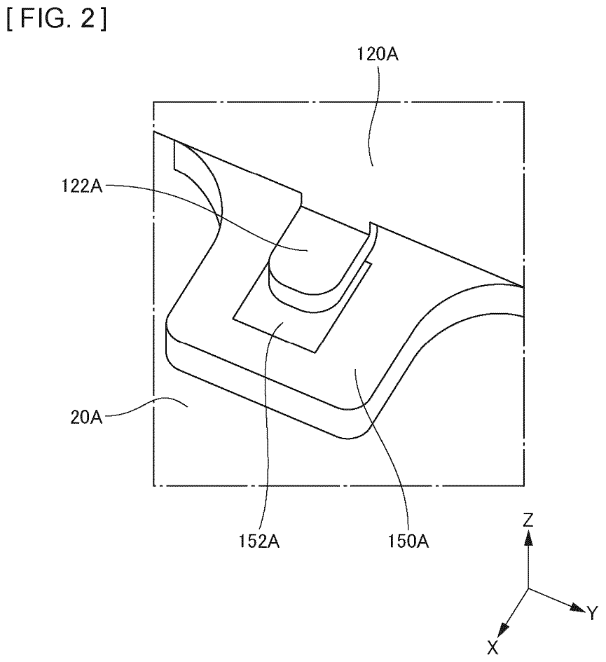

FIG. 1 is a perspective view of a vehicular antenna device 10A according to Embodiment 1. Hereinafter, the vehicular antenna device 10A is also simply referred to as an antenna device 10A. FIG. 2 is a diagram showing an example of a structure of a feeding portion of the antenna element 100A according to Embodiment 1.

The antenna device 10A according to Embodiment 1 will be described with reference to FIG. 1 and, as necessary, FIG. 2.

The antenna device 10A according to Embodiment 1 is attached to a metal roof of a vehicle. Specifically, the antenna device 10A is disposed inside a recess portion provided on the metal roof of the vehicle and is covered with a coating body such as a resin or glass. Hereinafter, unless otherwise specified, the antenna device 10A will be described as being attached to the metal roof of the vehicle.

The antenna device 10A according to Embodiment 1 includes a ground plate 20A and an antenna element 100A. The antenna element 100A includes a conductor plate 110A, a feeding conductor 120A, a ground conductor 130A, and a connection conductor 140A. The antenna element 100A is disposed on the upper surface side of the ground plate 20A. The antenna element 100A may be covered with a cover not illustrated. The antenna element 100A is operable in a frequency band of 600 MHz to 5 GHz, for example. The antenna element 100A is operable as a telephone (TEL) antenna. The antenna element 100A, however, may operate as an antenna different from the TEL antenna.

The conductor plate 110A is made of metal such as sheet metal. The conductor plate 110A is disposed above the ground plate 20A. The conductor plate 110A has a plate shape substantially parallel to the XY plane. The conductor plate 110A, however, may be inclined with respect to the XY plane. The lower surface of the conductor plate 110A and the upper surface of the ground plate 20A face each other in the Z direction across a gap.

As viewed in the Z direction, the feeding conductor 120A and the ground conductor 130A are located on opposite sides to each other in the X direction with respect to the center of the conductor plate 110A. The conductor plate 110A has a substantially quadrangular shape as viewed in the Z direction. Specifically, the conductor plate 110A has a substantially rectangular shape having a pair of short sides substantially parallel to the X direction and a pair of long sides substantially parallel to the Y direction as viewed from the Z direction. The feeding conductor 120A is provided on one of the pair of long sides of the conductor plate 110A as viewed in the Z direction. The ground conductor 130A is provided on the other of the pair of long sides of the conductor plate 110A as viewed in the Z direction.

In Embodiment 1, the feeding conductor 120A and the ground conductor 130A are provided on two different facing sides of the conductor plate 110A having a substantially quadrangular shape as viewed in the Z direction. That is, the feeding conductor 120A extends from one side portion of the conductor plate 110A toward the ground plate 20A, and the ground conductor 130A extends from the side portion opposite to the one side of the conductor plate 110A toward the ground plate 20A. The lower end portion of the feeding conductor 120A is a feeding portion of the antenna element 100A. The lower end portion of the ground conductor 130A is a ground portion short-circuited to the ground plate 20A. The greater electrical length of the antenna element 100A from the lower end portion of the feeding conductor 120A to the lower end portion of the ground conductor 130A can widen the operable band of the antenna element 100A toward a low frequency band. The operable band of the antenna element 100A, therefore, can be widened toward the low frequency band more by providing the feeding conductor 120A and the ground conductor 130A on the two facing sides of the conductor plate 110A than by providing the feeding conductor 120A and the ground conductor 130A on the two adjacent sides of the conductor plate 110A as viewed in the

The shape of the conductor plate 110A, however, is not Limited to the shape according to Embodiment 1. For example, the conductor plate 110A may have a substantially square shape as viewed in the Z direction. Alternatively, the conductor plate 110A may have a substantially polygonal shape, such as a substantially hexagonal shape or a substantially octagonal shape, as viewed in the Z direction, instead of a substantially quadrangular shape. Alternatively, the conductor plate 110A may have a substantially circular or substantially elliptical shape as viewed in the Z direction. When the conductor plate 110A has a substantially polygonal, substantially circular, or substantially elliptical shape as viewed in the Z direction, it is desirable that the feeding conductor 120A and the ground conductor 130A are provided at opposite end portions of the conductor plate 110A with respect to the center of the conductor plate 110A as viewed in the Z direction from the viewpoint of expanding the operable band of the antenna element 100A to the low frequency band.

The feeding conductor 120A is made of a metal such as sheet metal. As viewed in the Z direction, the feeding conductor 120A extends substantially parallel to the Z direction from one of the pair of long sides of the conductor plate 110A substantially parallel to the Y direction toward the ground plate 20A. The feeding conductor 120A has a plate shape substantially parallel to the YZ plane. The feeding conductor 120A, however, may be inclined with respect to the YZ plane.

The feeding conductor 120A is bent downward with respect to the conductor plate 110A. The antenna element 100A, therefore, can be easily manufactured in comparison with the case where the conductor plate 110A and the feeding conductor 120A are joined to each other by welding. The conductor plate 110A and the feeding conductor 120A, however, may be joined to each other by welding.

As viewed in the X direction, the feeding conductor 120A has a self-similar shape or an equivalent shape with reference to the lower end portion of the feeding conductor 120A. The “self-similar shape” is a shape that is similar in the shape even if the scale (size ratio) is changed. The operable band of the antenna element 100A can be widened to a high frequency band by the self-similar shape or the equivalent shape of the feeding conductor 120A. In the example shown in FIG. 1, the width of at least a portion of the feeding conductor 120A in the Y direction continuously decreases away from the conductor plate 110A in the Z direction. The feeding conductor 120A, therefore, has a substantially tapered shape as viewed in the X direction. Specifically, the width of the lower end portion of the feeding conductor 120A in the Y direction is substantially zero as viewed from the X direction. The feeding conductor 120A, therefore, has a substantially inverted triangle having a bottom side substantially parallel to the Y direction as viewed from the X direction. In this case, the voltage standing wave ratio (VSWR) in the high frequency band of about 3 GHz to 6 GHz can be easily reduced in comparison with the case where the width of the feeding conductor 120A in the Y direction is substantially constant regardless of the position in the Z direction.

In the example shown in FIG. 2, a protrusion 122A is provided at the lower end portion of the feeding conductor 120A. The protrusion 122A is bent in the X direction with respect to the feeding conductor 120A. A substrate 150A is disposed on the upper surface side of the ground plate 20A. For example, the substrate 150A is a printed circuit board (PCB). A conductor pattern 152A is provided on the substrate 150A. The protrusion 122A and the conductor pattern 152A are electrically connected to each other by a joining method such as soldering. Accordingly, the protrusion 122A is a feeding portion of the antenna element 100A. The structure of the feeding portion of the antenna element 100A, however, is not limited to the structure shown in FIG. 2.

The shape of the feeding conductor 120A is not limited to the shape according to Embodiment 1. For example, the width of the lower end portion of the feeding conductor 120A in the Y direction may be greater than zero. That is, the feeding conductor 120A may have a substantially inverted trapezoidal shape having two bottom sides substantially parallel to the Y direction as viewed from the X direction. Alternatively, the width of at least a portion of the feeding conductor 120A may decrease stepwise away from the conductor plate 110A in the Z direction. Alternatively, at least a portion of both sides of the feeding conductor 120A in the Y direction may be curved as viewed from the X direction. Alternatively, the width of the feeding conductor 120A in the Y direction may be substantially constant regardless of the position in the Z direction. Alternatively, the width of at least a portion of the feeding conductor 120A in the Y direction may continuously or stepwise increase away from the conductor plate 110A in the Z direction.

The ground conductor 130A is made of metal such as sheet metal. As viewed in the Z direction, the ground conductor 130A extends substantially parallel to the Z direction from the other of the pair of long sides of the conductor plate 110A substantially parallel to the Y direction toward the ground plate 20A. The ground conductor 130A has a plate shape substantially parallel to the YZ plane. The ground conductor 130A, however, may be inclined with respect to the YZ plane.

The ground conductor 130A is bent downward with respect to the conductor plate 110A. The antenna element 100A, therefore can be easily manufactured in comparison with the case where the conductor plate 110A and the ground conductor 130A are joined to each other by welding. The conductor plate 110A and the ground conductor 130A, however, may be joined to each other by welding.

In Embodiment 1, both the feeding conductor 120A and the ground conductor 130A are bent downward with respect to the conductor plate 110A. Only one of the feeding conductor 120A and the ground conductor 130A, however, may be bent downward with respect to the conductor plate 110A. In this case, the other of the feeding conductor 120A and the ground conductor 130A may be joined by welding.

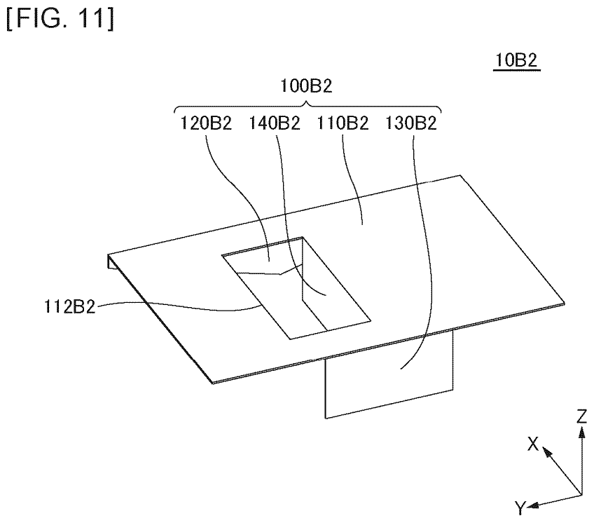

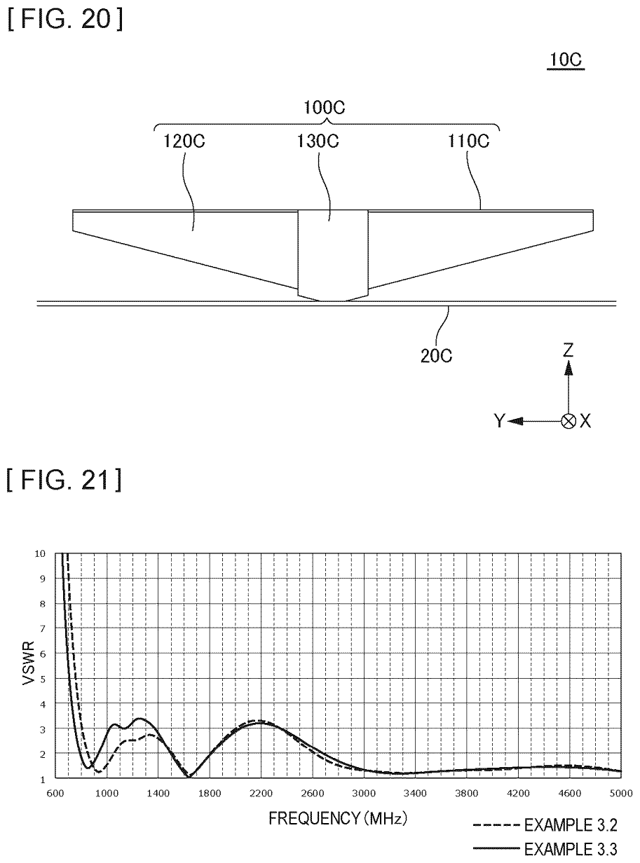

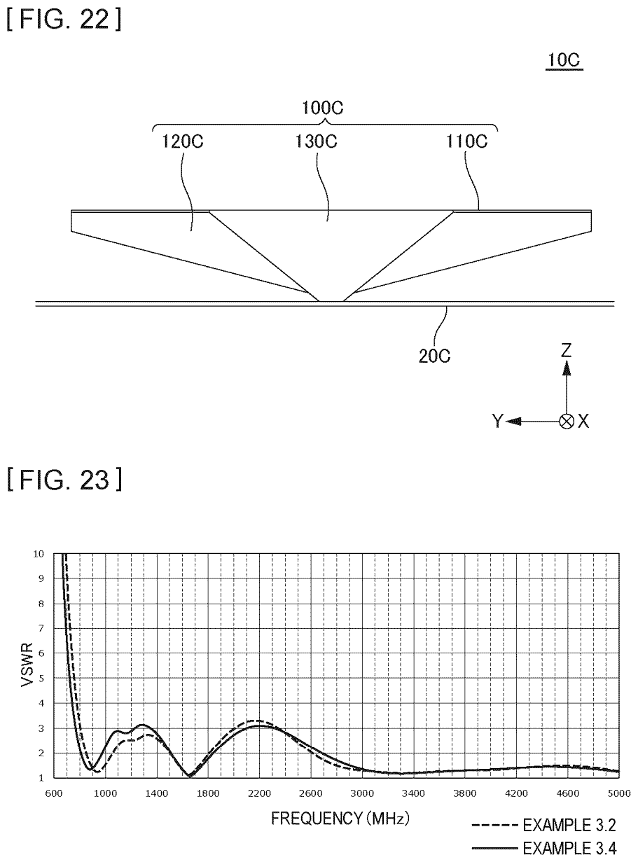

The width of at least a portion of the ground conductor 130A in the Y direction continuously decreases away from the conductor plate 110A in the Z direction. The ground conductor 130A, therefore, has a substantially tapered shape as viewed in the X direction. Specifically, the width of the lower end portion of the ground conductor 130A in the Y direction is substantially zero as viewed from the X direction. The ground conductor 130A, therefore, has a substantially inverted triangle shape having a bottom side substantially parallel to the Y direction as viewed from the X direction. The ground conductor 130A, however, may not have a substantially inverted triangular shape as viewed in the X direction. For example, as will be described with reference to FIGS. 11 and 20, the width of the ground conductor 130A in the Y direction may be substantially constant regardless of the position in the Z direction. Alternatively, the shape of the ground conductor 130A may be a shape as in a ground conductor 130C shown in FIG. 22 described later. In this case, the width of at least a portion of the ground conductor 130A in the Y direction may be shorter than the length of the portion of the conductor plate 110A on the opposite side to the one side. That is, the width of the ground conductor 130A in the Y direction may be less than the length of the side of the conductor plate 110A provided with the ground conductor 130A in the Y direction.

The lower end portion of the ground conductor 130A and the upper surface of the ground plate 20A are electrically connected to each other by a joining method such as soldering, welding, or screwing. Accordingly, the lower end portion of the ground conductor 130A is a ground portion short-circuited to the ground plate 20A.

The shape of the ground conductor 130A is not limited to the shape according to Embodiment 1. For example, as will be described later, the width of the lower end portion of the ground conductor 130A in the Y direction may be greater than zero. That is, the ground conductor 130A may have a substantially inverted trapezoidal shape having two bottom sides substantially parallel to the Y direction as viewed from the X direction. Alternatively, the width of at least a portion of the ground conductor 130A may be gradually decreased away from the conductor plate 110A in the Z direction. Alternatively, at least a portion of both sides of the ground conductor 130A in the Y direction may be curved as viewed from the X direction. Alternatively, the width of the ground conductor 130A in the Y direction may be substantially constant regardless of the position in the Z direction. Alternatively, the width of at least a portion of the ground conductor 130A in the Y direction may continuously or stepwise increase away from the conductor plate 110A in the Z direction. Alternatively, the ground conductor 130A may not have a plate shape.

In Embodiment 1, the shape of the feeding conductor 120A and the shape of the ground conductor 130A are substantially the same as each other as viewed in the X direction. The shape of the feeding conductor 120A and the shape of the ground conductor 130A, however, may be different from each other as viewed in the X direction. For example, the width of the lower end portion of the feeding conductor 120A in the Y direction and the width of the lower end portion of the ground conductor 130A in the Y direction may be different from each other while the width of the upper end portion of the feeding conductor 120A in the Y direction and the width of the upper end portion of the ground conductor 130A in the Y direction are substantially the same. Alternatively, the width of at least a portion of one of the feeding conductor 120A and the ground conductor 130A in the Y direction may continuously or stepwise decrease away from the conductor plate 110A in the Z direction while the width of the other of the feeding conductor 120A and the ground conductor 130A in the Y direction are substantially constant regardless of the position in the Z direction.

The connection conductor 140A is made of a metal such as sheet metal. The connection conductor 140A has a plate shape substantially parallel to the ZX plane. The connection conductor 140A, however, may be inclined with respect to the ZX plane. The connection conductor 140A is located between the lower surface of the conductor plate 110A and the upper surface of the ground plate 20A in the Z direction. As viewed in the Z direction, the connection conductor 140A is located between the feeding conductor 120A and the ground conductor 130A in the X direction. The connection conductor 140A is electrically connected to the ground plate 20A and the conductor plate 110A. The connection conductor 140A has a substantially rectangular shape having a pair of long sides substantially parallel to the X direction and a pair of short sides substantially parallel to the Z direction as viewed in the Y direction. That is, the width of the connection conductor 140A in the X direction is substantially constant regardless of the position in the Z direction. The connection conductor 140A is located substantially at the center of the conductor plate 110A in the Y direction as viewed in the Z direction. As will be described later, however, the connection conductor 140A may be displaced in the Y direction from the substantial center of the conductor plate 110A in the Y direction as viewed in the Z direction, and a plurality of connection conductors 140A may be provided.

The connection conductor 140a is electrically connected to the upper surface of the ground plate 20A and the lower surface of the conductor plate 110A. Specifically, the lower end portion of the connection conductor 140A and the upper surface of the ground plate 20A are electrically connected to each other by a joining method such as soldering, welding, or screwing. Accordingly, the lower end portion of the connection conductor 140A is a ground portion short-circuited to the ground plate 20A. The upper end portion of the connection conductor 140A and the lower surface of the conductor plate 110A are electrically connected to each other by a joining method such as soldering, welding, or screwing. Accordingly, the upper end portion of the connection conductor 140A is a connecting portion electrically connected to the conductor plate 110A.

The shape of the connection conductor 140A is not limited to the shape according to Embodiment 1. For example, as will be described later, the width of at least a portion of the connection conductor 140A in the X direction may decrease or increase continuously or stepwise away from the ground conductor 130A in the Z direction as viewed in the Y direction. Alternatively, the connection conductor 140A may not be a portion of the antenna element 100A but may be a portion of the ground plate 20A.

In Embodiment 1, the feeding conductor 120A, the ground conductor 130A, and the connection conductor 140A are supports that support the conductor plate 110A. The antenna element 100A, therefore, can stand alone without the need for a holder such as a resin holder that holds the antenna element 100A. Further, the conductor plate 110A can be more stably supported when the connection conductor 140A is provided than when the connection conductor 140A is not provided.

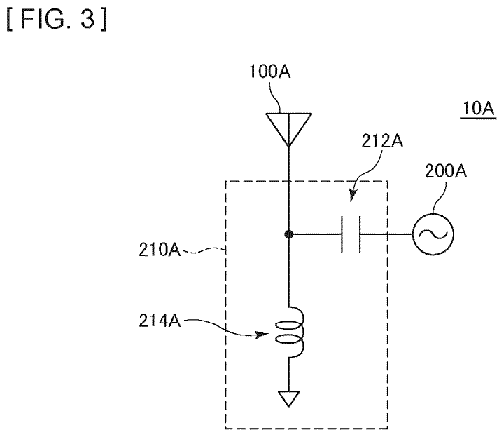

FIG. 3 is a diagram showing a configuration example of a matching circuit 210A of the antenna device 10A according to Embodiment 1.

The antenna device 10A includes a feeding circuit 200A and a matching circuit 210A. The antenna element 100A and the feeding circuit 200A are electrically connected to each other through a matching circuit 210A. The matching circuit 210A includes a capacitor 212A and an inductor 214A. The capacitor 212A is located between the antenna element 100A and the feeding circuit 200A in the electrical path. The inductor 214A is electrically connected to a portion between the antenna element 100A and the capacitor 212A in the electrical path.

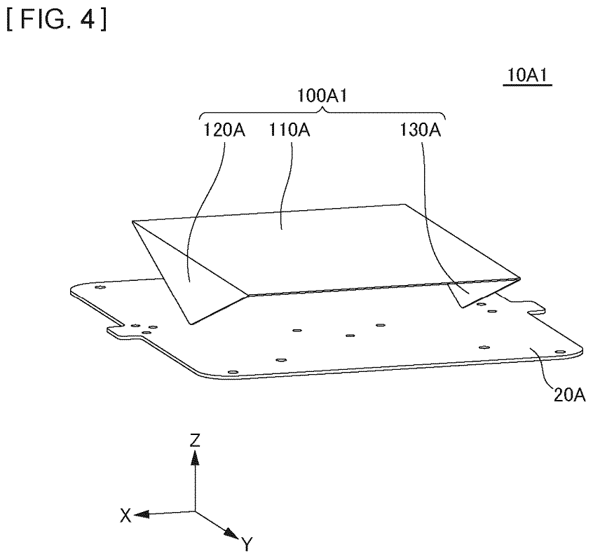

FIG. 4 is a perspective view of a vehicular antenna device 10A1 according to a reference embodiment. Hereinafter, the vehicular antenna device 10A1 is also simply referred to as an antenna device 10A1. The antenna element 100A1 of the antenna device 10A1 according to the present reference embodiment is the same as the antenna element 100A of the antenna device 10A according to Embodiment 1 except that the connection conductor 140A according to Embodiment 1 is not provided.

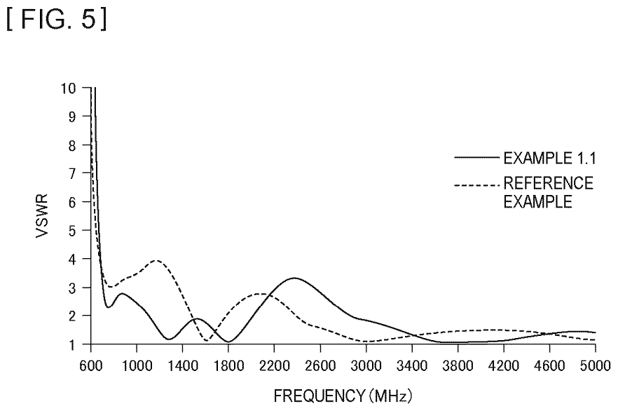

FIG. 5 is a graph showing frequency characteristics of the voltage standing wave ratio of the antenna device according to Example 1.1 and the reference example. In the graph shown in FIG. 5, the horizontal axis indicates a frequency (unit: MHz) and the vertical axis indicates a voltage standing wave ratio (VSWR).

The antenna device according to Example 1.1 is an example of the antenna device 10A according to Embodiment 1. Specifically, the length of the conductor plate 110A in the X direction and the length of the conductor plate 110A in the Y direction are 78 mm and 121 mm respectively. The height of each of the feeding conductor 120A and the ground conductor 130A in the Z direction is 22.5 mm. The width of each of the lower end portion of the feeding conductor 120A and the lower end portion of the ground conductor 130A in the Y direction is substantially zero (1.5 mm). The width of the connection conductor 140A in the X direction is 50 mm. A square metal plate having a side of 1 m parallel to the X direction and a side of 1 m parallel to the Y direction is used as the ground plate 20A of Example 1.1.

The antenna device according to the reference example is an example of the antenna device 10A1 according to the reference embodiment. Specifically, the antenna device according to Reference Example is the same as the antenna device according to Example 1.1 except that the connection conductor 140A is not provided.

As shown in FIG. 5, in both Example 1.1 and the reference example, the VSWR in a frequency band of 700 MHz to 5000 MHz is relatively low of 4 or less. The antenna device, therefore, can operate in the wide frequency band of 700 MHz to 5000 MHz by the feeding conductor 120A and the ground conductor 130A.

As shown in FIG. 5, the VSWR of Example 1.1 at 700 MHz to 1400 MHz is lower than the VSWR of the reference example at 700 MHz to 1400 MHz. The VSWR in the low frequency band of 700 MHz to 1400 MHz, therefore, can be reduced when the connection conductor 140A is provided in comparison with the case where the connection conductor 140A is not provided. Accordingly, the antenna device can operate in the wide frequency band when the connection conductor 140A is provided in comparison with the case where the connection conductor 140A is not provided.

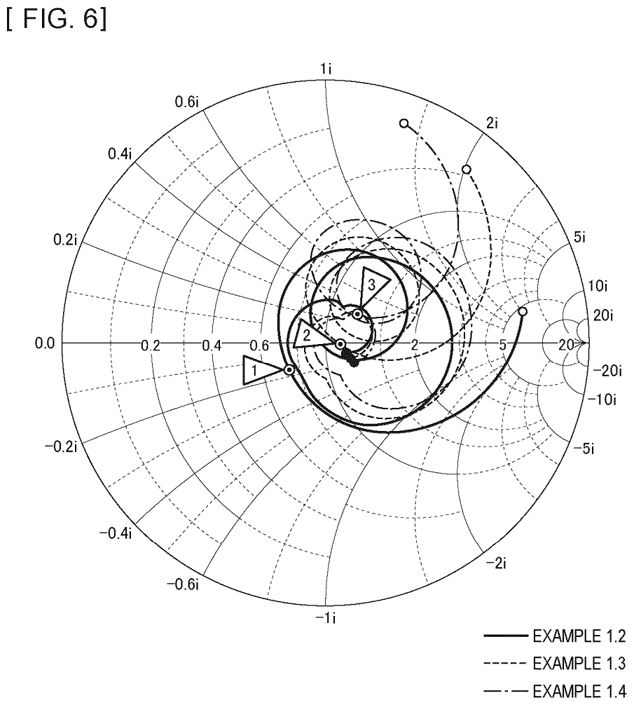

FIG. 6 is a Smith chart of the antenna devices according to Example 1.2, Example 1.3, and Example 1.4. The impedance in the Smith chart of FIG. 6 is standardized by 50 Ω. The numerical value attached to the horizontal line passing through the center of the Smith chart in FIG. 6 indicates the resistance. The numerical value attached to the outer peripheral line of the Smith chart in FIG. 6 indicates the reactance. The impedance in the Smith chart shown in FIG. 6 indicates inductivity for the plot in the upper half from the horizontal line passing through the center and indicates capacitance for the plot in the lower half from the horizontal line passing through the center.

The antenna device according to Example 1.2 is an example of the antenna device 10A according to Embodiment 1. Specifically, the length of the conductor plate 110A in the X direction and the length of the conductor plate 110A in the Y direction are 78 mm and 121 mm respectively. The height of each of the feeding conductor 120A and the ground conductor 130A in the Z direction is 22.5 mm. The width of each of the lower end portion of the feeding conductor 120A and the lower end portion of the ground conductor 130A in the Y direction is 25 mm. The width of the connection conductor 140A in the X direction is 50 mm. A square metal plate having a side of 1 m parallel to the X direction and a side of 1 m parallel to the Y direction is used as the ground plate 20A of Example 1.2.

The antenna device according to Example 1.3 is the same as the antenna device according to Example 1.2 except that the width of each of the lower end portion of the feeding conductor 120A and the lower end portion of the ground conductor 130A in the Y direction is 50 mm.

The antenna device according to Example 1.4 is the same as the antenna device according to Example 1.2 except that the width of each of the lower end portion of the feeding conductor 120A and the lower end portion of the ground conductor 130A in the Y direction is 60 mm.

In FIG. 6, the plots of Example 1.2, Example 1.3, and Example 1.4 show S₁₁ of the S parameter of the antenna device according to Example 1.2, Example 1.3, Example and 1.4 respectively. In FIG. 6, the white circle of each plot indicates S₁₁ of the S parameter at 699 MHz. In FIG. 6, the black circle of each plot indicates S₁₁ of the S parameter at 5000 MHz. In FIG. 6, the white circle with the black dot indicated by the triangle surrounding the number “1” indicates S₁₁ of the S parameter at 960 MHz in Example 1.2. In FIG. 6, the white circle with the black dot indicated by the triangle surrounding the number “2” indicates S₁₁ of the S parameter at 960 MHz in Example 1.3. In FIG. 6, the white circle with the black dot indicated by the triangle surrounding the number “3” indicates S₁₁ of the S parameter at 960 MHz in Example 1. 4.

In the Smith chart shown in FIG. 6, the VSWR decreases as the position approaches the location where the resistance is 1 and the reactance is 0. As shown in FIG. 6, the order of Example 1.2, Example 1.3, and Example 1.4 is the order of Examples close to the location where the resistance is 1 and the reactance is 0 from 960 MHz to 5000 MHz. The VSWR at 960 MHz to 5000 MHz, therefore, tends to decrease as the width of each of the lower end portion of the feeding conductor 120A and the lower end portion of the ground conductor 130A in the Y direction decreases.

Assuming the use in a predetermined frequency band, the impedance of the antenna device can be controlled by varying the width of each of the lower end portions of the feeding conductor 120A and the ground conductor 130A in the Y direction. In Example 1.4 shown in FIG. 6, for example, the S parameters of 699 MHz to 960 MHz, which indicate inductivity, can make matching even if the inductor 214A of the matching circuit 210A shown in FIG. 3 is omitted to remain only the capacitor 212A.

In Example 1.2, Example 1.3, and Example 1.4, the width of the upper end portion of the feeding conductor 120A in the Y direction and the width of the upper end portion of the ground conductor 130A in the Y direction are equal to the length of one side of the conductor plate 110A in the Y direction. Accordingly, the width of the lower end portion of the feeding conductor 120A in the Y direction is 20.7% in Example 1.2, 41.3% in Example 1.3, and 49.6% in Example 1.4 with respect to the length of one side of the conductor plate 110A in the Y direction. The width of the lower end portion of the ground conductor 130A in the Y direction is 20.7% in Example 1.2, 41.3% in Example 1.3, and 49.6% in Example 1.4 with respect to the length of one side of the conductor plate 110A in the Y direction. The reduction of the VSWR in the range of 960 MHz to 5000 MHz, therefore, requires the width of the lower end portion of the feeding conductor 120A in the Y direction to be, for example, 50% or less, preferably 45% or less, and more preferably 25% or less of the length of one side of the conductor plate 110A in the Y direction. The reduction of the VSWR in the range of 960 MHz to 5000 MHz requires the width of the lower end portion of the ground conductor 130A in the Y direction to be, for example, 50% or less, preferably 45% or less, and more preferably 25% or less of the length of one side of the conductor plate 110A in the Y direction.

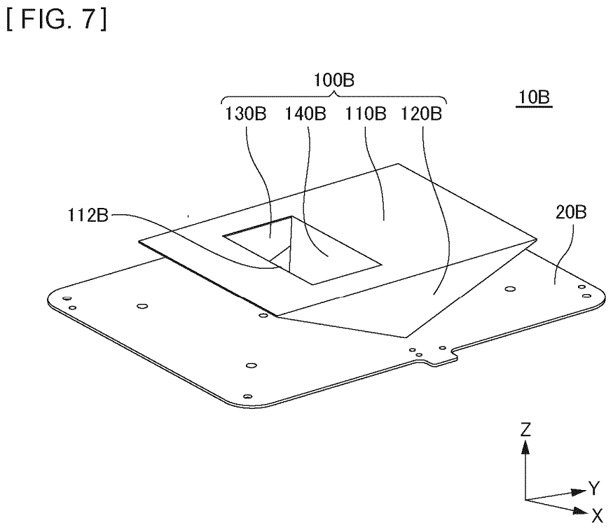

FIG. 7 is a perspective view of a vehicular antenna device 10B according to Embodiment 2. Hereinafter, the vehicular antenna device 10B is also simply referred to as an antenna device 10B. The antenna device 10B according to Embodiment 2 is the same as the antenna device 10A according to Embodiment 1 except for the following points.

The antenna device 10B according to Embodiment 2 includes a ground plate 20B and an antenna element 100B. The antenna element 100B is disposed on the upper surface side of the ground plate 20B. The antenna element 100B includes a conductor plate 110B, a feeding conductor 120B, a ground conductor 130B, and a connection conductor 140B.

The connection conductor 140B is bent downward with respect to the conductor plate 110B. Specifically, the connection conductor 140B is cut out from the conductor plate 110B. A slot 112B is provided in a portion of the conductor plate 110B from which the connection conductor 140B is cut out. The slot 112B has a substantially rectangular shape having a pair of long sides substantially parallel to the X direction and a pair of short sides substantially parallel to the Y direction as viewed in the Z direction. The shape of the slot 112B, however, is not limited to this example. As viewed in the Z direction, the upper end portion of the connection conductor 140B is located substantially at the center of the conductor plate 110B in the Y direction. The lower end portion of the connection conductor 140B and the upper surface of the ground plate 20B are electrically connected to each other by a joining method such as soldering, welding, or screwing. Accordingly, the lower end portion of the connection conductor 140B is a ground portion short-circuited to the ground plate 20B. The slot 112B of the cutout portion may be provided at a position displaced from the substantial center of the conductor plate 110B.

In Embodiment 2, the antenna element 100B can be easily manufactured in comparison with the case where the conductor plate 110B and the connection conductor 140B are joined to each other by welding. Specifically, in Embodiment 2, the antenna element 100B can be configured with one sheet of metal. The cost of configuring the antenna element 100B, therefore, can be reduced in comparison with the case where the antenna element 100B is configured with a plurality of sheets of metal plates.

Further, the size tolerance can be stabilized in comparison with the case where the antenna element 100B is formed of a plurality of sheets of metal plates. Further, the influence caused by the gap generated between the different sheet metals can be reduced in comparison with the case where the antenna element 100B is configured of a plurality of sheet metals. Further, the assembly process of the antenna element 100B can be decreased and the assembly of the antenna element 100B can be improved in comparison with the case where the antenna element 100B is configured with a plurality of sheets of metal.

In Embodiment 2, the feeding conductor 120B, the ground conductor 130B, and the connection conductor 140B are also supports that support the conductor plate 110B. The antenna element 100B, therefore, can stand alone without the need for a holder such as a resin holder that holds the antenna element 100B. The conductor plate 110B can be more stably supported when the connection conductor 140B is provided than when the connection conductor 140B is not provided.

In Embodiment 2, as in Embodiment 1, the antenna device 10B can also operate in the wide frequency band in comparison where the connection conductor 140B is not provided.

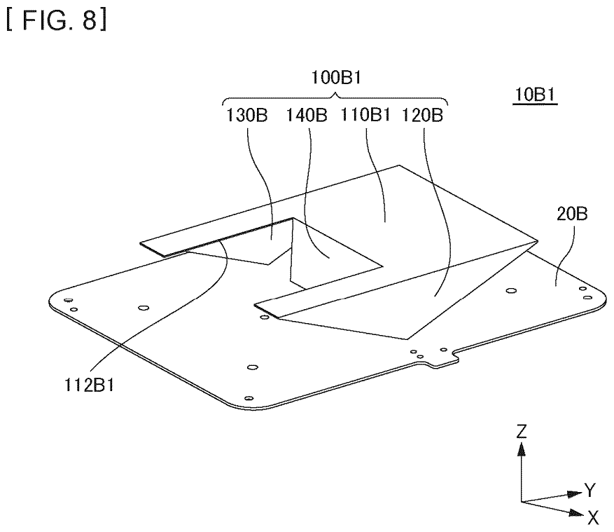

FIG. 8 is a perspective view of a vehicular antenna device 10B1 according to a first variant of Embodiment 2. Hereinafter, the vehicular antenna device 10B1 is also simply referred to as an antenna device 10B1. The antenna device 10B1 according to the present variant is the same as the antenna device 10B according to Embodiment 2 except for the following points.

As shown in FIG. 8, the conductor plate 110B1 of the antenna element 100B1 according to the present variant is provided with a slit 112B1 instead of the slot 112B according to Embodiment 2. That is, the end portion of one side of the conductor plate 110B1 in the Y direction is divided into two portions on both sides in the X direction by the slit 112B1. In the present variant, the antenna element 100B1 can also be configured with one sheet of metal plate. The antenna element 100B1 may be provided with both the slot 112B and the slit 112B1.

In the first variant of Embodiment 2, as in Embodiment 2, the antenna device 10B1 can also operate in the wide frequency band in comparison where the connection conductor 140B is not provided.

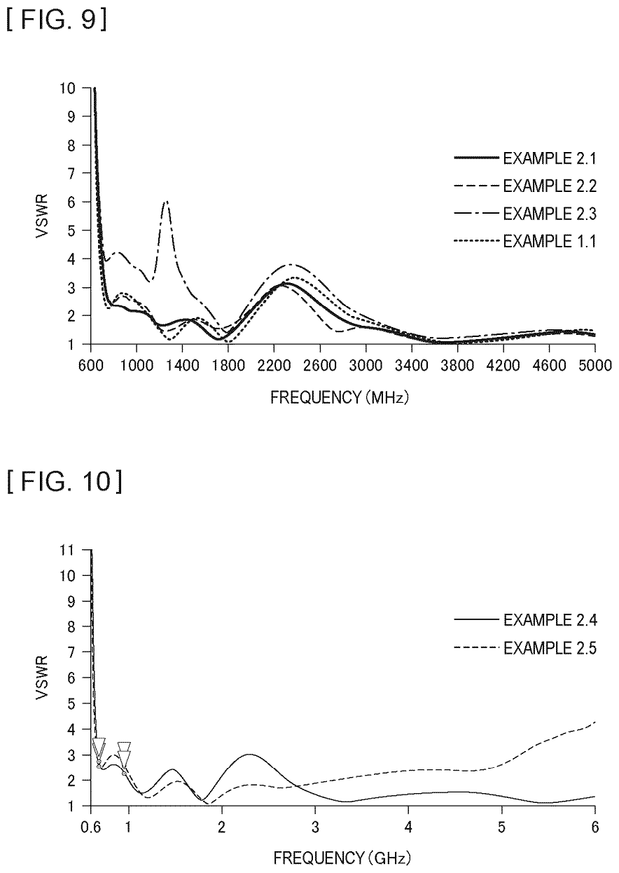

FIG. 9 is a graph showing frequency characteristics of the voltage standing wave ratio of the antenna devices according to Example 2.1, Example 2.2, Example 2.3, and Example 1.1.

The antenna device according to Example 2.1 is an example of the antenna device 10B according to Embodiment 2. Specifically, the length of the conductor plate 110B in the X direction and the length of the conductor plate 110B in the Y direction are 78 mm and 112 mm respectively. The length of the slot 112B in the X direction and the length of the slot 112B in the Y direction are 50 mm and 25 mm respectively. The height of each of the feeding conductor 120B and the ground conductor 130B in the Z direction is 22.5 mm. The width of each of the lower end portion of the feeding conductor 120B and the lower end portion of the ground conductor 130B in the Y direction is 1.5 mm. The width of the connection conductor 140B in the X direction is 50 mm. A square metal plate having a side of 1 m parallel to the X direction and a side of 1 m parallel to the Y direction is used as the ground plate 20B of Example 2.1.

The antenna device according to Example 2.2 is the same as the antenna device according to Example 2.1 except that the length of the slot 112B in the Y direction is 46 mm.

The antenna device according to Example 2.3 is an example of the antenna device 10B1 according to the first variant of Embodiment 2. Specifically, the antenna device according to Example 2.3 is the same as the antenna device according to Example 2.1 except that the slit 112B1 is provided instead of the slot 112B. The length of the slit 112B1 in the Y direction is 56 mm.

As shown in FIG. 9, the tendency of the VSWR in the frequency band of 600 MHz to 5000 MHz of Example 2.1 and Example 2.2 is almost the same as the tendency of the VSWR in the frequency band of 600 MHz to 5000 MHz of Example 1.1. The slot 112B provided in the conductor plate 110B, therefore, can have almost no influence on the tendency of the VSWR in the frequency band of 600 MHz to 5000 HMz.

As shown in FIG. 9, the tendency of the VSWR in a range of 1800 MHz to 5000 MHz in Example 2.3 is almost the same as the tendency of the VSWR in a range of 1800 MHz to 5000 MHz in Example 2.1 and Example 2.2. The slit 112B1 provided in the conductor plate 110B1, therefore, can have almost no influence on the tendency of the VSWR in a frequency band of 1800 MHz to 5000 MHz.

As shown in FIG. 9, the VSWR at 800 MHz to 1600 MHz of Example 2.1 and Example 2.2 is less than the VSWR of 800 MHz to 1600 MHz of Example 2.3. The reason is understood as follows. Hereinafter, as necessary, a side indicated by an arrow indicating the Y direction will be referred to as a +Y side, and a side opposite to the side indicated by the arrow indicating the Y direction will be referred to as a −Y side. In Example 2.3, as shown in FIG. 8, the end portion of the conductor plate 110B1 on the −Y side is cut out by the slit 112B1 as viewed in the Z direction. In Example 2.3, therefore, the electrical path of the antenna element 100B1 from the lower end portion of the feeding conductor 120B to the lower end portion of the ground conductor 130B is not formed on the −Y side portion with respect to the connection conductor 140B of the conductor plate 110B1 and is formed on the +Y side portion with respect to the connection conductor 140B of the conductor plate 110B1. In Example 2.1 and Example 2.2, on the other hand, as shown in FIG. 7, the end portion of the conductor plate 110B on the −Y side remains without being cut out by the slot 112B as viewed in the Z direction. In Example 2.1 and Example 2.2, therefore, the electrical path of the antenna element 100B from the lower end portion of the feeding conductor 120B to the lower end portion of the ground conductor 130B can be formed in both side portions of the slot 112B of the conductor plate 110B in the Y direction. Accordingly, the operable band of the antenna element 100B can be widened toward the low frequency band by the amount of the electrical path formed on the −Y side portion with respect to the slot 112B of the conductor plate 110B in Example 2.1 and Example 2.2 as compared with Example 2.3.

FIG. 10 is a graph showing frequency specification of the voltage standing wave ratio of the antenna apparatus according to Example 2.4 and Example 2.5. In the graph shown in FIG. 10, the horizontal axis indicates a frequency (unit: GHz) and the vertical axis indicates a voltage standing wave ratio (VSWR).

The antenna device according to Example 2.4 is an example of the antenna device 10B according to Embodiment 2. Specifically, the length of the conductor plate 110B in the X direction and the length of the conductor plate 110B in the Y direction are 78 mm and 112 mm respectively. The length of the slot 112B in the X direction and the length of the slot 112B in the Y direction are 50 mm and 32 mm respectively. The height of each of the feeding conductor 120B and the ground conductor 130B in the Z direction is 22.5 mm. The width of each of the lower end portion of the feeding conductor 120B and the lower end portion of the ground conductor 130B in the Y direction is 1.5 mm. The width of the connection conductor 140B in the X direction is 50 mm. A square metal plate having a side of 1 m parallel to the X direction and a side of 1 m parallel to the Y direction is used as the ground plate 20B of Example 2.4.

The antenna device according to Example 2.5 is the same as the antenna device according to Example 2.4 except that the width of each of the lower end portion of the feeding conductor 120B and the lower end portion of the ground conductor 130B in the Y direction is 30 mm.

In FIG. 10, the triangles attached to the plots of Example 2.4 and Example 2.5 in the vicinity of 0.7 GHz indicate the positions of the plots of Example 2.4 and Example 2.5 at 0. 69 GHz respectively. In FIG. 10, the triangles attached to the plots of Example 2.4 and Example 2.5 in the vicinity of 0.95 GHz indicate the positions of the plots of Example 2.4 and Example 2.5 at 0.96 GHz respectively.

As shown in FIG. 10, the VSWR at 3 GHz to 6 GHz in Example 2.4 is lower than the VSWR at 3 GHz to 6 GHz in Example 2.5. The VSWR at 3 GHz to 6 GHz, therefore, can be reduced by reducing the width of each of the lower end portion of the feeding conductor 120B and the lower end portion of the ground conductor 130B in the Y direction.

FIG. 11 is a perspective view of a vehicular antenna device 10B2 according to a second variant of Embodiment 2. Hereinafter, the vehicular antenna device 10B2 is also simply referred to as an antenna device 10B2. The antenna device 10B2 according to the present variant is the same as the antenna device 10B according to Embodiment 2 except for the following points.

The antenna element 100B2 according to the present variant has a conductor plate 110B2, a feeding conductor 120B2, a ground conductor 130B2, and a connection conductor 140B2. In the example shown in FIG. 11, the feeding conductor 120B2 and the ground conductor 130B2 are provided on two sides of the conductor plate 110B2 that face each other in the X direction. A slot 112B2 is present in a portion of the conductor plate 110B2 from which the connection conductor 140B2 is cut out.

As viewed in the X direction, the shape of the feeding conductor 120B2 and the shape of the ground conductor 130B2 are different from each other. Specifically, the width of at least a portion of the feeding conductor 120B2 in the Y direction continuously decreases away from the conductor plate 110B2 in the Z direction as viewed from the X direction. The width of the ground conductor 130B2 in the Y direction, on the other hand, is substantially constant regardless of the position in the Z direction as viewed from the X direction. As viewed in the X direction, the Y direction width of the ground conductor 130B2 is less than the Y direction length of the side of the conductor plate 110B2 provided with the ground conductor 130B2. In other words, the ground conductor 130B2 has a substantially rectangular shape having a pair of long sides substantially parallel to the Y direction and a pair of short sides substantially parallel to the Z direction as viewed from the X direction.

In the second variant of Embodiment 2, as in Embodiment 2, the antenna device 10B2 can also operate in the wide frequency band in comparison where the connection conductor 140B2 is not provided.

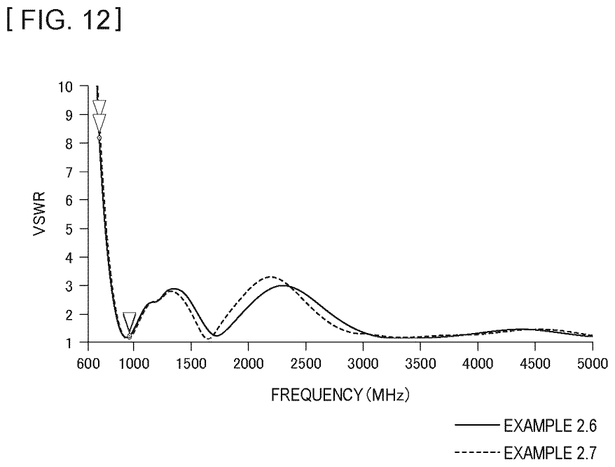

FIG. 12 is a graph showing frequency specification of the voltage standing wave ratio of the antenna devices according to Example 2.6 and Example 2.7. In the graph shown in FIG. 12, the horizontal axis indicates a frequency (unit: GHz) and the vertical axis indicates a voltage standing wave ratio (VSWR).

The antenna device according to Example 2.6 is an example of the antenna device 10B2 according to the second variant of Embodiment 2. Specifically, the length of the conductor plate 110B2 in the X direction and the length of the conductor plate 110B2 in the Y direction are 78 mm and 112 mm respectively. The length of the slot 112B2 in the X direction and the length of the slot 112B2 in the Y direction are 50 mm and 32 mm respectively. The height of each of the feeding conductor 120B2 and the ground conductor 130B2 in the Z direction is 22.5 mm. The width of the lower end portion of the feeding conductor 120B2 in the Y direction is 1.5 mm. The width of the ground conductor 130B2 in the Y direction is 40 mm. The width of the connection conductor 140B in the X direction is 50 mm. A square metal plate having a side of 1 m parallel to the X direction and a side of 1 m parallel to the Y direction is used as a ground plate of Example 2.6.

The antenna device according to Example 2.7 is the same as the antenna device according to Example 2.6 except that the shape of the ground conductor is the same as the shape of the feeding conductor according to Example 2.6 as viewed from the X direction.

As shown in FIG. 12, the frequency characteristics of the VSWR of the antenna device according to Example 2.6 are substantially the same as the frequency characteristics of the VSWR of the antenna device according to Example 2.7. Accordingly, even if the width of the ground conductor 130B2 in the Y direction is substantially constant regardless of the position in the Z direction, the ground conductor 130B2 having the width in the Y direction less than the Y direction length of the side of the conductor plate 110B2 provided with the ground conductor 130B2 can realize almost the same frequency characteristics of the VSWR as when the width of at least a portion of the ground conductor 130B2 in the Y direction decreases away from the conductor plate 110B2 in the Z direction.

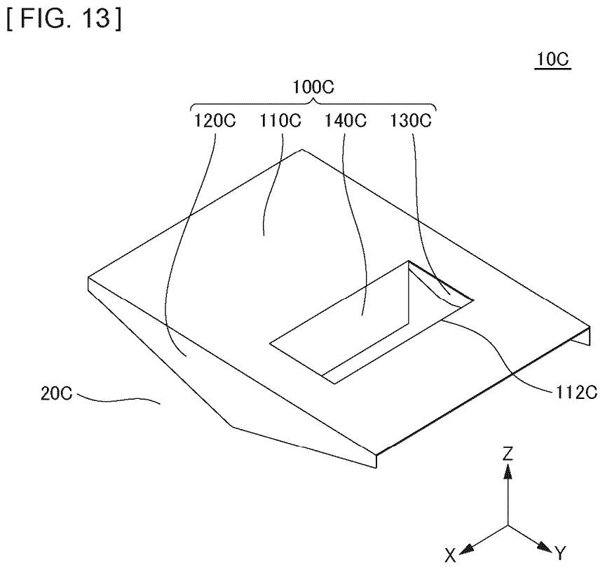

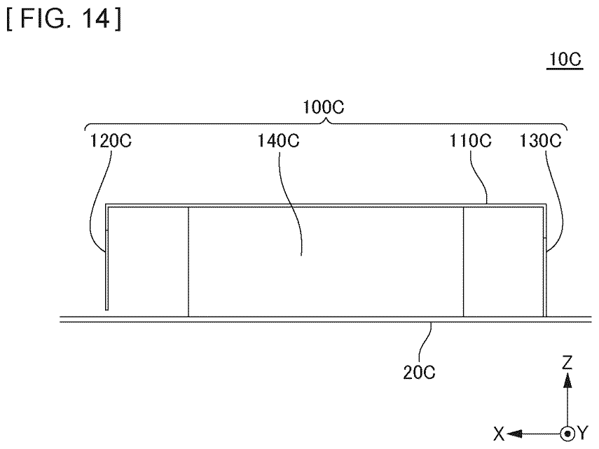

FIG. 13 is a perspective view of a vehicular antenna device 10C according to Embodiment 3. FIG. 14 is a side view of the vehicular antenna device 10C according to Embodiment 3 as viewed from the horizontal direction perpendicular to the arrangement direction of the feeding conductor 120C and the ground conductor 130C. In FIG. 14, the white circle with the black dot indicating the Y direction indicates that the arrow indicating the Y direction is directed toward the front side of the paper surface. Hereinafter, the vehicular antenna device 10C is also simply referred to as an antenna device 10C. The antenna device 10C according to Embodiment 3 is the same as the antenna device 10B according to Embodiment 2 except for the following points.

The antenna device 10C according to Embodiment 3 includes a ground plate 20C and an antenna element 100C, as does the antenna device 10B according to Embodiment 2. The antenna element 100C according to Embodiment 3 is disposed on the upper surface side of the ground plate 20C in the same way as the antenna element 100B according to Embodiment 2. The antenna element 100C according to Embodiment 3 has a conductor plate 110C, a feeding conductor 120C, a ground conductor 130C, and a connection conductor 140C, as does the antenna element 100B according to Embodiment 2. The conductor plate 110C according to Embodiment 3 is provided with a slot 1120 in the same way as the conductor plate 110B according to Embodiment 2.

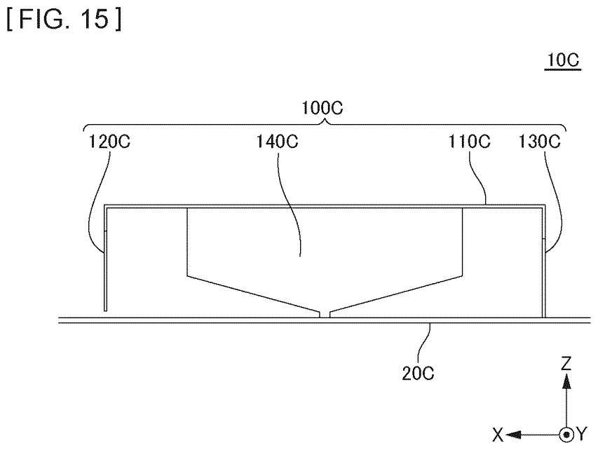

As viewed in the X direction, the feeding conductor 120C according to Embodiment 3 has a self-similar shape or an equivalent shape with reference to the lower end portion of the feeding conductor 120C, as does the feeding conductor 120A according to Embodiment 1 and the feeding conductor 120B according to Embodiment 2. As shown in FIG. 13, the width of at least a portion of the feeding conductor 120C in the Y direction continuously decreases away from the conductor plate 110C in the Z direction. Specifically, the width of the upper end portion of the feeding conductor 120C in the Y direction is substantially constant regardless of the position in the Z direction. The width of the portion of the feeding conductor 120C in the Y direction below the upper end portion of the feeding conductor 120C continuously decreases away from the conductor plate 110C in the Z direction. In FIG. 14, a gap is depicted as existing present between the upper surface of the ground plate 20C and the lower end portion of the feeding conductor 120C. A substrate not illustrated in FIG. 14, however, is actually disposed in the gap between the upper surface of the ground plate 20C and the lower end portion of the feeding conductor 120C in the same way as in the example described with reference to FIG. 2. In FIGS. 15, 17, 18, and 19, a substrate (not shown) is also disposed as in FIG. 14.

As shown in FIG. 13, the width of at least a portion of the ground conductor 1300 in the Y direction continuously decreases away from the conductor plate 110C in the Z direction. Specifically, the width of the upper end portion of the ground conductor 1300 in the Y direction is substantially constant regardless of the position in the Z direction. The width of the portion of the ground conductor 130C in the Y direction below the upper end portion of the ground conductor 130C continuously decreases away from the conductor plate 110C in the Z direction.

As shown in FIG. 13, the connection conductor 140C is bent downward with respect to the conductor plate 110C. As shown in FIG. 14, the connection conductor 140C has a substantially rectangular shape having a pair of long sides substantially parallel to the X direction and a pair of short sides substantially parallel to the Z direction as viewed in the Y direction. The lower long side of the connection conductor 140C and the upper surface of the ground plate 20C are electrically connected to each other by a joining method such as soldering, welding, or screwing. Accordingly, the lower long side of the connection conductor 140C is a ground portion short-circuited to the ground plate 200.

In Embodiment 3, as in Embodiment 1, the antenna device 10C can also operate in the wide frequency band in comparison where the connection conductor 140C is not provided. In Embodiment 3, as in Embodiment 2, the manufacture of the antenna element 100C can be facilitated in comparison with the case where the conductor plate 110C and the connection conductor 1400 are joined to each other by welding.

FIG. 15 is a side view of the vehicular antenna device 10C according to the first variant of Embodiment 3 as viewed from the horizontal direction perpendicular to the arrangement direction of the feeding conductor 120C and the ground conductor 130C. The antenna device 10C according to the present variant is the same as the antenna device 100 according to Embodiment 3 except for the following points.

As shown in FIG. 15, as viewed in the Y direction, the width of the connection conductor 1400 in the X direction from the upper end portion of the connection conductor 140C to the intermediate portion between the upper end portion and the lower end portion of the connection conductor 140C in the Z direction is substantially constant regardless of the position in the Z direction. As viewed in the Y direction, the width of the connection conductor 140C in the X direction from the intermediate portion of the connection conductor 140C to the lower end portion of the connection conductor 140C decreases away from the conductor plate 110C in the Z direction. The connection conductor 140C has a substantially symmetrical shape as viewed in the Y direction. The substantially central portion of the lower end portion of the connection conductor 1400 in the X direction and the upper surface of the ground plate 200 are electrically connected to each other by a joining method such as soldering, welding, or screwing. Accordingly, the substantially central portion of the lower end portion of the connection conductor 140C in the X direction is a ground portion short-circuited to the ground plate 20C.

In the first variant of Embodiment 3, as in Embodiment 3, the antenna device 10C can also operate in the wide frequency band in comparison where the connection conductor 140C is not provided.

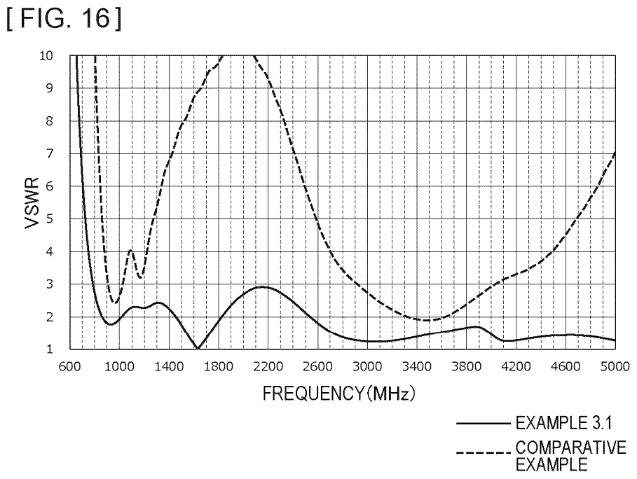

FIG. 16 is a graph showing frequency characteristics of the voltage standing wave ratio of the antenna apparatus according to Example 3.1 and Comparative Example.

The antenna device according to Example 3.1 is an example of the antenna device 10C according to the first variant of Embodiment 3.

The antenna device according to Comparative Example is the same as the antenna device according to Example 3.1 except that the lower end portion of the feeding conductor 1200 is short-circuited to the ground plate 20C without being fed and the lower end portion of the connection conductor 140C is fed without being short-circuited to the ground plate 20C.

In the antenna device according to Comparative Example, as shown in FIG. 16, the VSWR is greater than 3 at about 1000 MHz to about 2800 MHz and about 4000 MHz to about 5000 MHz. In the antenna device according to Example 3.1, on the other hand, the VSWR is 3 or less at about 800 MHz to about 5000 MHz. Accordingly, the antenna device according to Example 3.1 can operate in the wide frequency band as compared to the antenna device according to Comparative Example.

The reason why the antenna device according to Example 3.1 can operate in a wider frequency band than the antenna device according to Comparative Example is understood as follows.

In the antenna device according to Comparative Example, the lower end portion of the connection conductor 140C is fed, and the lower end portion of the feeding conductor 120C and the lower end portion of the ground conductor 130C are short-circuited to the ground plate 20C. Accordingly, the electrical length of the antenna element 100C according to Comparative Example is at longest the electrical length from the lower end portion of the connection conductor 140C to the lower end portion of the feeding conductor 120C or the electrical length from the lower end portion of the connection conductor 1400 to the lower end portion of the ground conductor 130C. In the antenna device according to Example 3.1, on the other hand, the lower end portion of the feeding conductor 120C is fed, and the lower end portion of the ground conductor 130C and the lower end portion of the connection conductor 140C are short-circuited to the ground plate 20C. In the antenna element 100C according to Example 3.1, therefore, an electrical length greater than any electrical length of the antenna element 100C according to Comparative Example can be formed from the lower end portion of the feeding conductor 120C to the lower end portion of the ground conductor 130C. Accordingly, the electrical length from the lower end portion of the feeding conductor 1200 to the lower end portion of the ground conductor 130C can widen the operable band of the antenna device according to Example 3.1 toward a low frequency band as compared with the operable band of the antenna device according to Comparative Example.

From the description of the above reason, the size of the antenna element 100C according to Example 3.1 can be less than the size of the antenna element 100C according to Comparative Example depending on the band required as the operable band of the antenna device. That is, the shorter the distance in the X direction between the feeding conductor 120C and the ground conductor 130C is, the shorter the electrical length of the antenna element 100C from the lower end portion of the feeding conductor 120C to the lower end portion of the ground conductor 130C is. The shorter the electrical length of the antenna element 100C from the lower end portion of the feeding conductor 120C to the lower end portion of the ground conductor 130C is, the narrower the width of the operable low frequency band of the antenna device is. As long as the narrowing width of the operable low frequency band of the antenna device is acceptable, however, the size of the antenna element 100C according to Example 3.1 can be less than the size of the antenna element 100C according to Comparative Example.

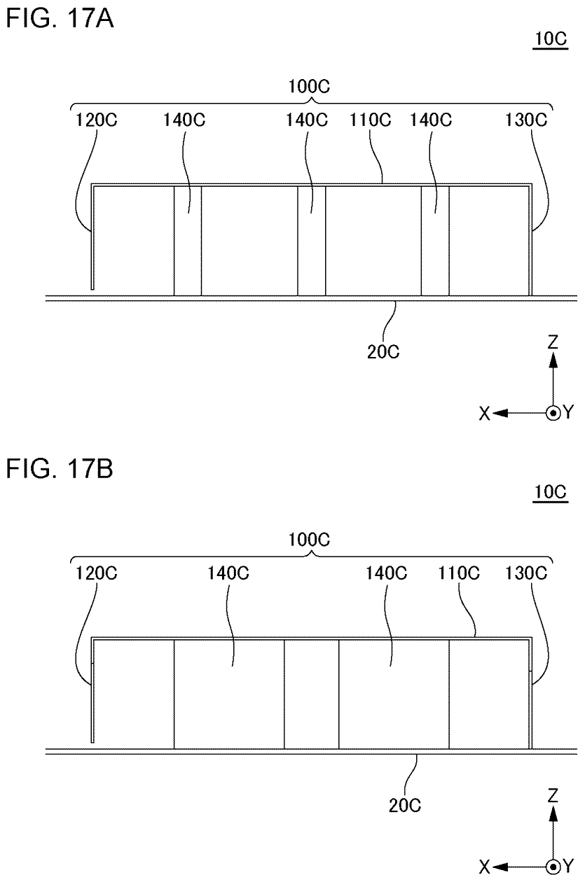

FIG. 17(a) and FIG. 17(b) are side views of the vehicular antenna device 10C according to the second variant of Embodiment 3 as viewed from the horizontal direction perpendicular to the arrangement direction of the feeding conductor 1200 and the ground conductor 130C. The antenna device 10C according to the example shown in FIG. 17(a) and FIG. 17(b) is the same as the antenna device 100 according to Embodiment 3 except for the following points.

The antenna element 100C according to the example shown in FIG. 17(a) and FIG. 17(b) includes a plurality of connection conductors 140C. Specifically, in the example shown in FIG. 17(a), three connection conductors 140C are arranged at substantially the same intervals in the X direction. The central connection conductor 1400 of the three connection conductors 140C is located at a substantially equal distance from the feeding conductor 1200 and the ground conductor 1300 in the X direction. In the example shown in FIG. 17(b), the two connection conductors 140C are located at approximately equal distances to the opposite sides of the substantially central portion of the region between the feeding conductor 120C and the ground conductor 1300 in the X direction. The number and arrangement of the plurality of connection conductors 140C, however, are not limited to this example.

As viewed in the Y direction, each connection conductor 140C has a substantially rectangular shape having a pair of short sides substantially parallel to the X direction and a pair of long sides substantially parallel to the Z direction as shown in FIG. 17(a), or has a substantially square shape having a pair of sides substantially parallel to the X direction and a pair of other sides substantially parallel to the Z direction as shown in FIG. 17(b). The shape of each connection conductor 140C, however, is not limited to this example.

In the second variant of Embodiment 3, as in Embodiment 3, the antenna device 10C can also operate in the wide frequency band in comparison where a plurality of the connection conductors 140C are not provided.

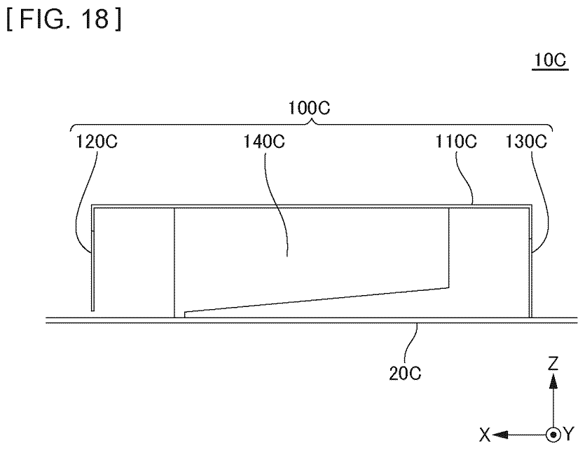

FIG. 18 is a side view of the vehicular antenna device 10C according to the third variant of Embodiment 3 as viewed from the horizontal direction perpendicular to the arrangement direction of the feeding conductor 120C and the ground conductor 130C. The antenna device 10C according to the present variant is the same as the antenna device 10C according to Embodiment 3 except for the following points.

The connection conductor 140C of the antenna element 100C according to the present variant has an asymmetric shape as viewed in the Y direction. Specifically, as viewed in the Y direction, the lower side of the connection conductor 140C is inclined upward from the side where the feeding conductor 120C is located toward the side where the ground conductor 1300 is located. The end portion of the lower side of the connection conductor 140C at the side where the feeding conductor 120C is located and the upper surface of the ground plate 200 are electrically connected to each other by a joining method such as soldering, welding, or screwing. Accordingly, the end portion of the lower side of the connection conductor 140C at the side where the feeding conductor 120C is located is a ground portion short-circuited to the ground plate 20C. The shape of the connection conductor 140C is not limited to this example. For example, as viewed in the Y direction, the lower side of the connection conductor 140C may be inclined upward from the side where the ground conductor 130C is located to the side where the feeding conductor 120C is located.

In the third variant of Embodiment 3, as in Embodiment 3, the antenna device 100 can also operate in the wide frequency band in comparison where the connection conductor 140C is not

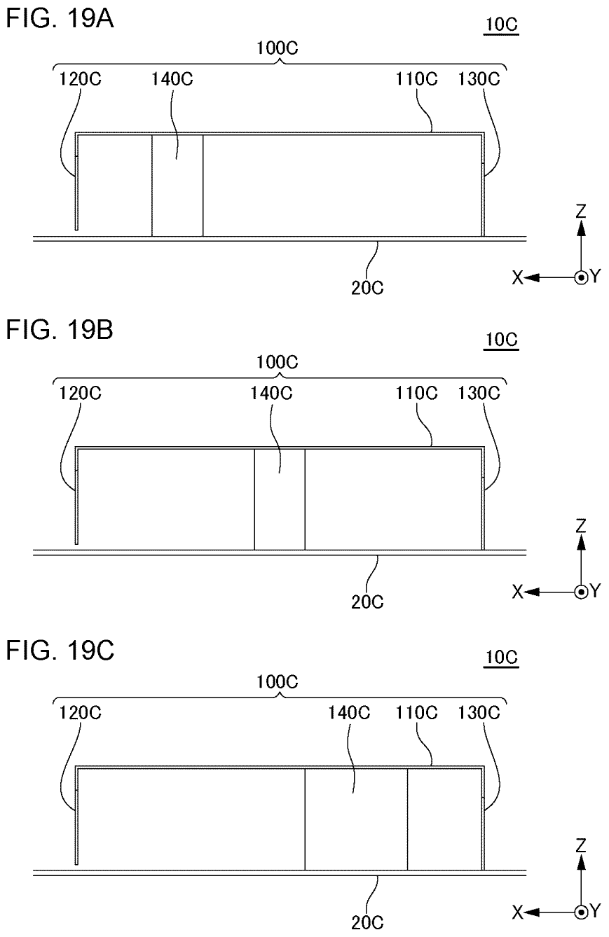

FIG. 19(a), FIG. 19(b), and FIG. 19(c) are side views of the vehicular antenna device 100 according to the fourth variant of Embodiment 3 as viewed from the horizontal direction perpendicular to the arrangement direction of the feeding conductor 120C and the ground conductor 130C. The antenna device 10C according to the present variant is the same as the antenna device 10C according to Embodiment 3 except for the following points.

The connection conductor 140C of the antenna element 100C according to the examples shown in FIG. 19(a) and FIG. 19(b) has a substantially rectangular shape having a pair of short sides substantially parallel to the X direction and a pair of long sides substantially parallel to the Z direction as viewed in the Y direction. The connection conductor 140C of the antenna element 100C according to the example shown in FIG. 19(c) has a substantially square shape having a pair of sides substantially parallel to the X direction and the other pair of sides substantially parallel to the Z direction as viewed in the Y direction. The shape of each connection conductor 140C, however, is not limited to the examples shown in FIG. 19(a), FIG. 19(b), and FIG. 19(c).

The connection conductor 140C shown in FIG. 19(a) is located closer to the feeding conductor 120C than to the ground conductor 130C in the X direction as viewed in the Y direction, t. The connection conductor 140C shown in FIG. 19(b) is located at a substantially equal distance from the feeding conductor 120C and the ground conductor 1300 in the X direction as viewed in the Y direction. The connection conductor 140C shown in FIG. 19(c) is located closer to the ground conductor 1300 than to the feeding conductor 120C in the X direction as viewed in the Y direction. The position of the connection conductor 140C, however, is not limited to the examples shown in FIG. 19(a), FIG. 19(b), and FIG. 19(c).

In the fourth variant of Embodiment 3, as in Embodiment 3, the antenna device 100 can also operate in the wide frequency band in comparison where the connection conductor 140C is not provided.

FIG. 20 is a side view of the vehicular antenna device 10C according to the fifth variant of Embodiment 3 as viewed from the side where the ground conductor 130C is located. In FIG. 20, the white circle with the X indicating the X direction indicates that the arrow indicating the X direction is directed toward the back side of the paper surface. The antenna device 10C according to the present variant is the same as the antenna device 10C according to Embodiment 3 except for the following points.

As viewed in the X direction, the width of the ground conductor 130C of the antenna element 100C according to the present variant in the Y direction is substantially constant regardless of the position in the Z direction except for the lower end portion of the ground conductor 130C. As viewed in the X direction, the Y direction width of the upper end portion of the ground conductor 130C is less than the Y direction length of the side of the conductor plate 110 provided with the ground conductor 130C. As viewed in the X direction, the width of the lower end portion of the ground conductor 1300 in the Y direction continuously decreases away from the conductor plate 110C in the Z direction.

FIG. 21 is a graph showing frequency characteristics of the voltage standing wave ratio of the antenna device according to Example 3.2 and Example 3.3.

The antenna device according to Example 3.2 is an example of the antenna device 10C according to Embodiment 3. In the antenna device according to Example 3.2, the Y direction length of the upper end portion of the ground conductor 130C and the Y direction length of the side of the conductor plate 1100 provided with the ground conductor 130C are each 110 mm.

The antenna device according to Example 3.3 is an example of the antenna device 10C according to the fifth variant of Embodiment 3. The antenna device according to Example 3.3 is the same as the antenna device according to Example 3.2 except that the length of the upper end portion of the ground conductor 130C in the Y direction is 15 mm.

In Example 3.2, as shown in FIG. 21, the VSWR is 4 or less at about 800 MHz to about 5000 MHz. In Example 3.3, on the other hand, the VSWR is 4 or less at about 750 MHz to about 5000 MHz. Accordingly, the operable band of the antenna device according to Example 3.3 is wider in the low frequency band than the operable band of the antenna device according to Example 3.2.

The reason why the operable band of the antenna device according to Example 3.3 is wider in the low frequency band than the operable band of the antenna device according to Example 3.2 is understood as follows.

In Example 3.2, the Y direction length of the upper end portion of the ground conductor 130C is equal to the Y direction length of the side of the conductor plate 110C provided with the ground conductor 130C. In Example 3.3, on the other hand, the Y direction length of the upper end portion of the ground conductor 130C is less than the Y direction length of the side of the conductor plate 110C provided with the ground conductor 130C. Accordingly, the electric length of the antenna element 100C from the lower end portion of the feeding conductor 1200 to the lower end portion of the ground conductor 130C through both end portions of the conductor plate 110C in the Y direction in Example 3.3 can be greater than the electric length of the antenna element 100C from the lower end portion of the feeding conductor 1200 to the lower end portion of the ground conductor 130C through both end portions of the conductor plate 110C in the Y direction in Example 3.2. The operable band of the antenna device according to Example 3.3, therefore, can be widened toward the low frequency band as compared with the operable band of the antenna device according to Example 3.2.

Similar to the example described with reference to FIG. 3, the antenna element 100C according to Example 3.3 and the feeding circuit may be electrically connected to each other through the matching circuit. When the matching circuit is provided, the VSWR at 699 MHz to 5000 MHz in Example 3.3 can be improved in comparison with the case where the matching circuit is not provided.

FIG. 22 is a side view of the vehicular antenna device 10C according to the sixth variant of Embodiment 3 as viewed from the side where the ground conductor 1300 is located. Hereinafter, the vehicular antenna device 10C is also simply referred to as an antenna device 10C. The antenna device 10C according to the present variant is the same as the antenna device 10C according to Embodiment 3 except for the following points.

As viewed in the X direction, the taper angle of the ground conductor 130C of the antenna element 1000 according to the present variant is less than the taper angle of the feeding conductor 120C. The tapered angle of the ground conductor 130C is the sum of both angles of both sides of the ground conductor 130C in the Y direction with respect to the Z direction as viewed from the X direction. The taper angle of the feeding conductor 120C is the sum of both angles of both sides of the feeding conductor 1200 in the Y direction with respect to the Z direction as viewed in the X direction. As viewed in the X direction, the Y direction width of the upper end portion of the ground conductor 130C is less than the Y direction length of the side of the conductor plate 110C provided with the ground conductor 130C.

FIG. 23 is a graph showing frequency characteristics of the voltage standing wave ratio of the antenna device according to Example 3.2 and Example 3.4.

The antenna device according to Example 3.2 is an example of the antenna device 10C according to Embodiment 3. In the antenna device according to Example 3.2, the taper angle of the ground conductor 130C is 150 degrees.

The antenna device according to Example 3.4 is an example of the antenna device 10C according to the sixth variant of Embodiment 3. The antenna device according to Example 3.4 is the same as the antenna device according to Example 3.2 except that the taper angle of the ground conductor 130C is 100 degrees.

In Example 3.2, as shown in FIG. 23, the VSWR is 4 or less at about 800 MHz to about 5000 MHz. In Example 3.4, on the other hand, the VSWR is 4 or less at about 775 MHz to about 5000 MHz. Accordingly, the operable band of the antenna device according to Example 3.4 is wider in the low frequency band than the operable band of the antenna device according to Example 3.2.

The reason why the operable band of the antenna device according to Example 3.4 is wider in the low frequency band than the operable band of the antenna device according to Example 3.2 in the low frequency band is understood to be the same as the reason why the operable band of the antenna device according to Example 3.3 is wider in the low frequency band than the operable band of the antenna device according to Example 3.2.

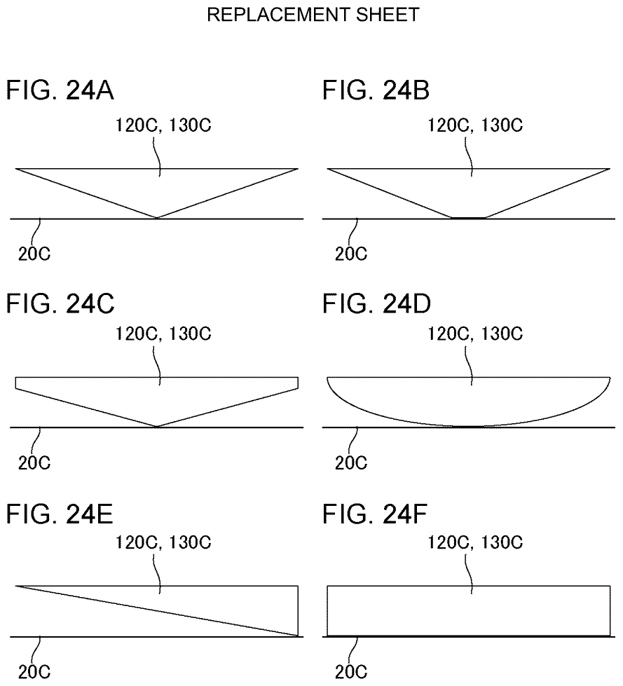

FIG. 24(a), FIG. 24(b), FIG. 24(c), FIG. 24(d), FIG. 24(e), and FIG. 24(f) are side views of the feeding conductor 120C or the ground conductor 130 according to the seventh variant of Embodiment 3 as viewed from the horizontal direction parallel to the arrangement direction of the feeding conductor 120C and the ground conductor 130C.

As shown in FIG. 24(a) to FIG. 24(f), the feeding conductor 120C and the ground conductor 130C can have various shapes. For example, as shown in FIG. 24(a), at least one of the feeding conductor 120C or the ground conductor 130C may have a substantially inverted isosceles triangle shape. In the example shown in FIG. 24(a), the width of at least one of the feeding conductor 120C or the ground conductor 130C decreases toward the ground plate 20C. Alternatively, as shown in FIG. 24(b), at least one of the feeding conductor 1200 or the ground conductor 130C may have a substantially inverted isosceles trapezoidal shape. In the example shown in FIG. 24(b), the width of at least one of the feeding conductor 120C or the ground conductor 130C decreases toward the ground plate 20C. Alternatively, as shown in FIG. 24(c), at least one of the feeding conductor 120C or the ground conductor 130C may have a substantially pentagonal shape. In the example shown in FIG. 24(c), the width of at least one the upper portions of the feeding conductor 120C or the ground conductor 130C is substantially constant regardless of the position in the direction perpendicular to the ground plate 20C, and the width from the center portion to the lower end portion of at least one of the feeding conductor 1200 or the ground conductor 130C decreases toward the ground plate 20C. Alternatively, as shown in FIG. 24(d), the outer edge the feeding conductor 120C and the ground conductor 130C at the side where the ground plate 20C is located may have a substantially arc shape. Alternatively, as shown in FIG. 24(e), at least one of the feeding conductor 120C or the ground conductor 130C may have a substantially right-angled triangular shape having a hypotenuse at the side where the ground plate 20C is located. Alternatively, as shown in FIG. 24(f), at least one of the feeding conductor 120C or the ground conductor 130C may have a substantially rectangular shape. The shapes of the feeding conductor 120C and the ground conductor 130C, however, are not limited to the examples shown in FIG. 24(a) to FIG. 24(f).

It is preferable that the feeding conductor 120C has a self-similar shape or an equivalent shape with reference to the lower end portion of the feeding conductor 120C. The feeding conductor 120C, however, may have a shape different from the self-similar shape or the equivalent shape.

In the seventh variant of Embodiment 3, as in Embodiment 3, the antenna device 10C can also operate in the wide frequency band in comparison where the connection conductor 140C is not provided.

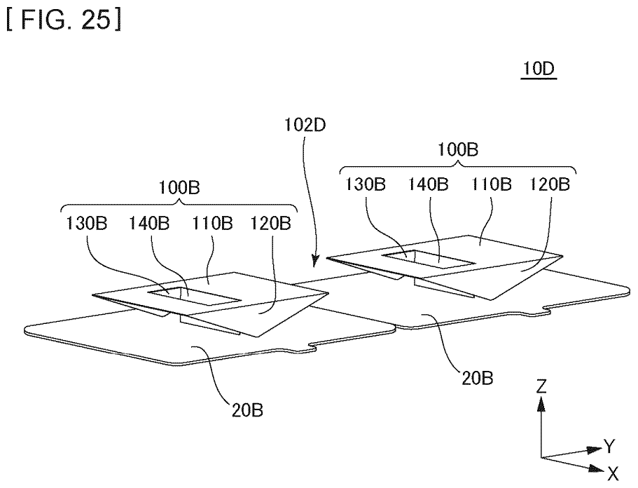

FIG. 25 is a perspective view of a vehicular antenna device 10D according to Embodiment 4. Hereinafter, the vehicular antenna device 10D is also simply referred to as an antenna device 10D. The antenna device 10D according to Embodiment 4 is the same as the antenna device 10B according to Embodiment 2 except for the following points.

The antenna device 10D according to Embodiment 4 includes the two antenna elements 100B according to Embodiment 2. The two antenna elements 100B are arranged in the Y direction with the feeding conductor 120B and the ground conductor 130B of each antenna element 100B arranged in the X direction. The two antenna elements 100B arranged in the Y direction are spaced apart from each other by a predetermined distance 102D. The predetermined distance 102D indicates the shortest distance between the opposed sides of the conductor plates 110B of the adjacent antenna elements 100B. In this case, the isolation between the two antenna elements 100B can be easily ensured in comparison with the case where the two antenna elements 100B are arranged in the Y direction with the feeding conductor 120B and the ground conductor 130B of each antenna element 100B arranged in the Y direction. The two antenna elements 100B, however, may be arranged in the Y direction with the feeding conductor 120B and the ground conductor 130B of each antenna element 100B arranged in the Y direction.

The two antenna elements 100B are disposed in substantially the: same orientation in the Y direction. Specifically, the feeding conductor 120B of one of the two antenna elements 100B and the feeding conductor 120B of the other of the two antenna elements 100B are disposed on the same side of the two antenna elements 100B in the X direction. The ground conductor 130B of one of the two antenna elements 100B and the ground conductor 130B of the other of the two antenna elements 100B are disposed on the same side in the X direction of the two antenna elements 100B.

The two antenna elements 100B according to Embodiment 4 can operate as multiple input multiple output (MIMO) antennas. In Embodiment 4, the isolation between the two antenna elements 100B can be ensured by adjusting the length of the predetermined distance 102D in the Y direction to an appropriate length.

The antenna device 10D may include three or more antenna elements arranged in a predetermined direction. The structure of at least one of the antenna elements provided in the antenna device 10D may be different from the structure of at least another one of the antenna elements provided in the antenna device 10D. For example, the antenna device 10D may include at least one antenna element 100A according to Embodiment 1 and at least one antenna element 100B according to Embodiment 2.

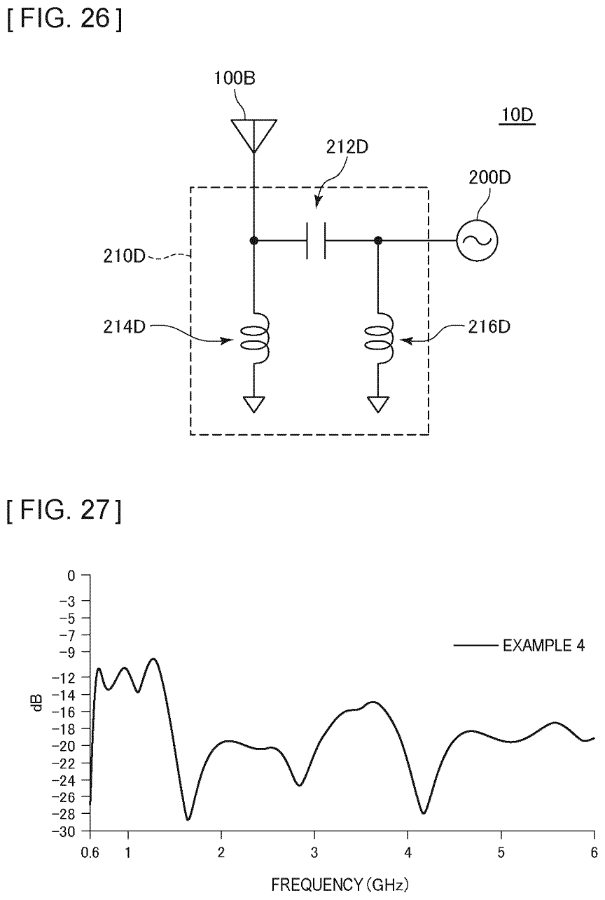

FIG. 26 is a diagram showing a configuration example of a matching circuit 210D of the antenna device 10D according to Embodiment 4.

The antenna device 10D includes a feeding circuit 200D and a matching circuit 210D. The antenna element 100B shown in FIG. 26 corresponds to one of the two antenna elements 100B shown in FIG. 25. That is, the configuration example of the matching circuit of the other of the two antenna elements 100B shown in FIG. 25 is also the same as the configuration example shown in FIG. 26.

The antenna element 100B and the feeding circuit 200D are electrically connected to each other through the matching circuit 210D. The matching circuit 210D includes a capacitor 212D, a first inductor 214D, and a second inductor 216D. The capacitor 212D is located between the antenna element 100B and the feeding circuit 200D in the electrical path. The first inductor 214D is electrically connected to a portion between the antenna element 100B and the capacitor 212D in the electrical path. The second inductor 216D is electrically connected to a portion between the feeding circuit 200D and the capacitor 212D in the electrical path.

FIG. 27 is a graph showing frequency characteristics of isolation of the antenna device according to Example 4. In the graph shown in FIG. 27, the horizontal axis indicates a frequency (unit: GHz) and the vertical axis indicates isolation (unit: dB).

The antenna device according to Example 4 is an example of the antenna device 10D according to Embodiment 4. Specifically, the length of the conductor plate 110B of each antenna element 100B in the X direction and the length of the conductor plate 110B of each antenna element 100B in the Y direction are 78 mm and 112 mm respectively. The length of the slot 112B of each antenna element 100B in the X direction and the length of the slot 112B of each antenna element 100B in the Y direction are 50 mm and 32 mm respectively. The height of each of the feeding conductor 120B and the ground conductor 130B of each antenna element 100B in the Z direction is 22.5 mm. The width of each of the lower end portion of the feeding conductor 120B and the lower end portion of the ground conductor 130B of each antenna element 100B in the Y direction is 1.5 mm. The width of the connection conductor 140B of each antenna element 100B in the X direction is 50 mm. The length of the predetermined distance 102D in the Y direction between the two antenna elements 100B is 30 mm. The length 30 mm in the Y direction of the predetermined distance 102D is about 0.06 times, such as greater than or equal to 0.05 times and less than or equal to 0.07 times the wavelength of the lowest frequency 600 MHz in the operation frequency band of each antenna element 100B. The operation frequency band of each antenna element 100B is a frequency band each antenna element 100B supports. A square metal plate having a side of 1 m parallel to the X direction and a side of 1 m parallel to the Y direction is used as the ground plate 20B of Example 4.

In Example 4, as shown in FIG. 27, the isolation in almost the entire band of 0.6 GHz to 6 GHz is −10 dB or less.

Accordingly, the isolation of −10 dB or less can be ensured in a desired frequency band. The isolation of the two antenna elements 100B, therefore, can be ensured by adjusting the length of the predetermined distance 102D in the Y direction between the two antenna elements 100B to an appropriate length.

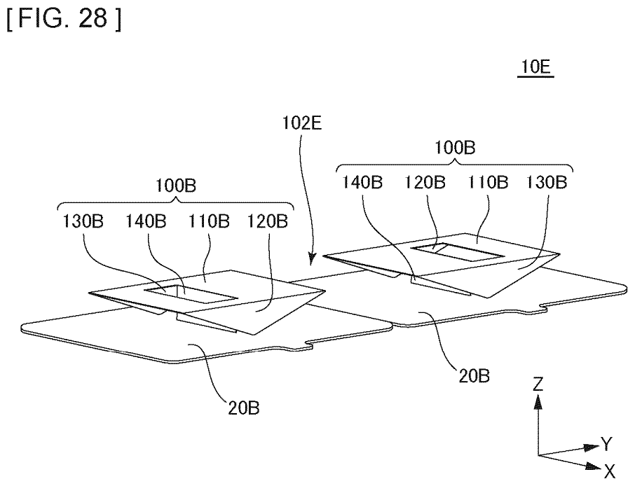

FIG. 28 is a perspective view of a vehicular antenna device 10E according to Embodiment 5. Hereinafter, the vehicular antenna device 10E is also simply referred to as an antenna device 10E. The antenna device 10E according to Embodiment 5 is the same as the antenna device 10D according to Embodiment 4 except for the following points.

The antenna device 10E according to Embodiment 5 includes the two antenna elements 100B according to Embodiment 2. The two antenna elements 100B are arranged in the Y direction with the feeding conductor 120B and the ground conductor 130B of each antenna element 100B arranged in the X direction. The conductor plate 110B of each antenna element 100B has opposite two sides by a predetermined distance 102E between the two antenna elements 100B arranged in the Y direction.

The two antenna elements 100B are disposed in inverted orientations in the Y direction. Specifically, the feeding conductor 120B of one of the two antenna elements 100B and the feeding conductor 120B of the other of the two antenna elements 100B are disposed on opposite sides of the two antenna elements 100B in the X direction. The ground conductor 130B of one of the two antenna elements 100B and the ground conductor 130B of the other of the two antenna elements 100B are disposed on opposite sides of the two antenna elements 100B in the X direction.

The two antenna elements 100B according to Embodiment 5 can also operate as the MIMO antenna. In Embodiment 5, the isolation between the two antenna elements 100B can be also ensured by adjusting the length of the predetermined distance 102E in the Y direction to an appropriate length.

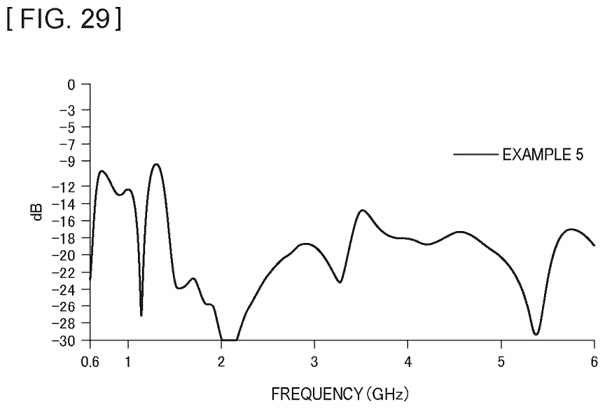

FIG. 29 is a graph showing frequency characteristics of isolation of the antenna device according to Example 5.

The antenna device according to Example 5 is an example of the antenna device 10E according to Embodiment 5. Specifically, the length of the conductor plate 110B of each antenna element 100B in the X direction and the length of the conductor plate 110B of each antenna element 100B in the Y direction are 78 mm and 112 mm respectively. The length of the slot 112B of each antenna element 100B in the X direction and the length of the slot 112B of each antenna element 100B in the Y direction are 50 mm and 32 mm respectively. The height of each of the feeding conductor 120B and the ground conductor 130B of each antenna element 100B in the Z direction is 22.5 mm. The width of each of the lower end portion of the feeding conductor 120B and the lower end portion of the ground conductor 130B of each antenna element 100B in the Y direction is 1.5 mm. The width of the connection conductor 140B of each antenna element 100B in the X direction is 50 mm. The length of the predetermined distance 102E in the Y direction between the two antenna elements 100B is 30 mm. The length 30 mm in the Y direction of the predetermined distance 102E is about 0.06 times, such as greater than or equal to 0.05 times and less than or equal to 0.07 times the wavelength of the lowest frequency 600 MHz in the operation frequency band of each antenna element 100B. A square metal plate having a side of 1 m parallel to the X direction and a side of 1 m parallel to the Y direction is used as the ground plate 20B of Example 5.

In Example 5, as shown in FIG. 29, the isolation in almost the entire band of 0.6 GHz to 6 GHz is −10 dB or less. Accordingly, the isolation of −10 dB or less can be ensured in a desired frequency band. The isolation between the two antenna elements 100B, therefore, can be ensured by adjusting the length of the predetermined distance 102E in the Y direction between the two antenna elements 100B to an appropriate length.

From the results shown in FIG. 27 and the results shown in FIG. 29, the isolation between the two antenna elements 100B can be ensured by adjusting the length of the gap between two adjacent antenna elements 100B to an appropriate length regardless of the orientation of each antenna element 100B.

Hitherto, the embodiments, the variants, and the examples of the present invention have been described above with reference to the drawings, but these are examples of the present invention, and various configurations other than the above description can be employed.

In each of the embodiments and each of the variants, the antenna device attached to the metal roof of the vehicle has been described. The antenna device, however, may be installed in a portion of the vehicle other than the metal roof. For example, the antenna device may be installed in any part in the cabin of the vehicle, a spoiler, or a bumper. The antenna device may be an antenna device other than the vehicular antenna device, such as an antenna device (an antenna device for a moving object) that is installed on a moving object other than the vehicle, such as construction machinery, agricultural machinery, a robot, or a drone.

In each of the embodiments and each of the variants, the antenna element is described as being operable as a TEL antenna. The antenna element, however, may operate as an antenna different from the TEL antenna. For example, the antenna element may be an antenna element capable of at least one of transmitting and receiving linearly polarized waves, such as an antenna for telematics or an antenna for mobile communication. Examples of the use application of the antenna element include intelligent transport systems (ITS), digital television (DTV), vehicle-to-everything (V2X), multiple-input multiple-output (MIMO), Wi-Fi®, Bluetooth®, keyless entry, and smart entry.

According to the present specification, a vehicular antenna device of the following aspects is provided.

### Aspect 1

In Aspect 1, a vehicular antenna device includes a ground plate and an antenna element disposed on an upper surface side of the ground plate. The antenna element includes a conductor plate facing the ground plate, a feeding conductor extending toward the ground plate from one side portion of the conductor plate, a ground conductor extending toward the ground plate from an opposing portion of the conductor plate opposite the one side portion, and a connection conductor located between the feeding conductor and the ground conductor and electrically connected to the ground plate and the conductor plate.

According to the aspect described above, the VSWR in the low frequency band can be reduced in comparison with the case where the connection conductor is not provided. The vehicular antenna device, therefore, can operate in the wide frequency band in comparison where the connection conductor is not provided.

### Aspect 2

In Aspect 2, the connection conductor is bent with respect to the conductor plate.

According to the aspect described above, the manufacture of the vehicular antenna device can be facilitated in comparison with the case where the conductor plate and the connection conductor are joined to each other by welding.

### aspect 3

In Aspect 3, a width of at least a portion of at least one of the feeding conductor or the ground conductor decreases away from the conductor plate.

According to the aspect described above, the VSWR in the high frequency band can be easily reduced in comparison with the case where the width of the feeding conductor is substantially constant or the case where the width of the ground conductor is substantially constant.

### Aspect 4

In Aspect 4, a width length of at least a portion of the ground conductor is less than a length of the opposing portion of the conductor plate.

According to the aspect described above, almost the same frequency characteristics of the VSWR can be realized as when the width of at least a portion of the ground conductor decreases away from the conductor plate.

### Aspect 5

In Aspect 5, at least one of the feeding conductor or the ground conductor is bent with respect to the conductor plate.

According to the aspect described above, the vehicular antenna device can be easily manufactured in comparison with the case where the conductor plate and the feeding conductor are joined to each other by welding or the case where the conductor plate and the ground conductor are joined to each other by welding.

### Aspect 6

In Aspect 6, there is a plurality of antenna elements, and the plurality of antenna elements is arranged in a predetermined 1.5 direction.

According to the aspect described above, a plurality of antenna elements can operate as the MIMO antenna.

### aspect 7

In Aspect 7, a shortest distance between opposite sides of conductor plates of adjacent antenna elements of the plurality of antenna elements is greater than or equal to 0.05 times a wavelength of a lowest frequency in frequency bands the plurality of antenna elements supports.

According to the aspect described above, the isolation of the plurality of antenna elements can be ensured by adjusting the shortest distance between the opposite sides of the conductor plates of the adjacent antenna elements to an appropriate length of greater than or equal to 0.05 times the wavelength of the lowest frequency of the frequency bands the plurality of antenna elements supports.

### Aspect 8

In Aspect 8, at least a portion of the conductor plate is cut out.

According to the aspect described above, the antenna element can be configured with one sheet of metal plate.

### Aspect 9

In Aspect 9, the conductor plate has a polygonal shape, the feeding conductor extends from the one side of sides forming the polygonal shape, the ground conductor extends from a side opposite the one side of the sides, and a width length of a lower end portion of at least one of the feeding conductor or the ground conductor is 50% or less of a length of the side to which the at least one is connected.

In at least one of the feeding conductor or the ground conductor, the shorter the length of the respective end portion on the side facing the ground plate is, the lower the VSWR in the predetermined frequency band tends to be. According to the aspect described above, the VSWR in a predetermined frequency band can be reduced.

### Aspect 11

In Aspect 11, a plurality of the connection conductors is disposed.

According to the aspect described above, even if a plurality of connection conductors is disposed, the vehicular antenna device can operate in the wide frequency band in comparison where the connection conductor is not provided.

This application claims priority based on Japanese Patent Application No. 2022-154708 filed on Sep. 28, 2022, the entire disclosure of which is incorporated herein by reference.

### REFERENCE SIGNS LIST

10A, 10A1, 10B, 10B1, 10B2, 10C, 10D, 10E vehicular antenna device
20A, 20B, 20C ground plate
100A, 100A1, 100B, 100B1, 100B2, 100C antenna element
102D, 102E predetermined distance
110A, 110B, 110B1, 110B2, 110C conductor plate
112B, 112B2, 112C slot
120A, 120B, 120B2, 120C feeding conductor
122A protrusion
130A, 130B, 130B2, 130C ground conductor
140A, 140B, 140B2, 140C connection conductor
150A substrate
200A, 200D feeding circuit
210A, 210D matching circuit

1. A vehicular antenna device comprising:
a ground plate; and
an antenna element disposed on an upper surface side of the ground plate,
wherein the antenna element includes
a conductor plate facing the ground plate,
a feeding conductor extending toward the ground plate from one side portion of the conductor plate,
a ground conductor extending toward the ground plate from an opposing portion of the conductor plate opposite the one side portion, and
a connection conductor located between the feeding conductor and the ground conductor and electrically connected to the ground plate and the conductor plate.

2. The vehicular antenna device according to claim 1,
wherein the connection conductor is bent with respect to the conductor plate.

3. The vehicular antenna device according to claim 1,
wherein a width of at least a portion of at least one of the feeding conductor or the ground conductor decreases away from the conductor plate.

4. The vehicular antenna device according to claim 1,
wherein a width length of at least a portion of the ground conductor is less than a length of the opposing portion of the conductor plate.

5. The vehicular antenna device according to claim 1,
wherein at least one of the feeding conductor or the ground conductor is bent with respect to the conductor plate.

6. The vehicular antenna device according to claim 1,
wherein there is a plurality of antenna elements, and
the plurality of antenna elements is arranged in a predetermined direction.

7. The vehicular antenna device according to claim 6,
wherein a shortest distance between opposite sides of conductor plates of adjacent antenna elements of the plurality of antenna elements is greater than or equal to 0.05 times a wavelength of a lowest frequency in frequency bands the plurality of antenna elements supports.

8. The vehicular antenna device according to claim 1,
wherein at least a portion of the conductor plate is cut out.

9. The vehicular antenna device according to claim 1,
wherein the conductor plate has a polygonal shape,
the feeding conductor extends from the one side of sides forming the polygonal shape,
the ground conductor extends from a side opposite the one side of the sides, and
a width length of a lower end portion of at least one of the feeding conductor or the ground conductor is 50% or less of a length of the side to which the at least one is connected.

10. The vehicular antenna device according to claim 1,
wherein a plurality of the connection conductors is disposed.
